(19) United States
(12) Patent Application Publication
(10) Pub. No.: US 2025/0158762 A1
(43) Pub. Date: May 15, 2025

(54) UPLINK DATA TRANSMITTING DEVICE AND METHOD, AND UPLINK DATA RECEIVING DEVICE AND METHOD

(71) Applicant: FUJITSU LIMITED, Kawasaki-shi (JP)

(72) Inventors: Jian ZHANG, Beijing (CN); Gang SUN, Beijing (CN); Xin WANG, Beijing (CN)

(73) Assignee: FUJITSU LIMITED, Kawasaki-shi (JP)

(21) Appl. No.: 19/027,578

(22) Filed: Jan. 17, 2025

Related U.S. Application Data
(63) Continuation of application No. PCT/CN2022/110657, filed on Aug. 5, 2022.

(51) Int. Cl. H04L 5/00; H04B 7/0456

(52) U.S. Cl. CPC H04L 5/0044; H04B 7/0456

(57) ABSTRACT

An uplink data transmitting device configured in a terminal equipment, wherein the terminal equipment is configured with two SRS resource sets, includes: a first receiver configured to receive third downlink control information for scheduling uplink data within a first application time, wherein at least part of the uplink data is within a second application time; and a first transmitter configured to determine to perform a first uplink data transmission based on a single transmission and reception point (sTRP) or perform a second uplink data transmission based on multiple transmission and reception points (mTRP) for the uplink data within the second application time, according to one or more parameters indicated by the third downlink control information; wherein the uplink data comprises at least one of uplink data types: an uplink repetition (PUSCH repetition) type A; an uplink repetition (PUSCH repetition) type B; or PUSCHs simultaneously transmitted with a multi-panel transmission scheme.

### CROSS-REFERENCE TO RELATED APPLICATION

This application is a continuation application of International Application PCT/CN2022/110657 filed on Aug. 5, 2022, and designated the U.S., the entire contents of which are incorporated herein by reference.

### TECHNICAL FIELD

Embodiments of this disclosure relate to the field of communication technologies.

### BACKGROUND

The 3GPP standard organization performed standardization-related operations on unified transmission configuration indication (TCI) in the standardization process of release 17 (Rel-17). The unified TCI in Rel-17 was primarily designed for a single transmission and reception point (sTRP) scenario.

Multiple transmission and reception points (mTRP) have become an important scenario for a 5G NR system with the advancement of standardization operations, and can achieve a purpose of increasing throughput or improving reliability through mTRP-based transmission.

In previous standardization operations, an mTRP-based transmission of a physical downlink shared channel (PDSCH) was standardized in Rel-16; mTRP-based transmissions of a physical downlink control channel (PDCCH), a physical uplink shared channel (PUSCH), and a physical uplink control channel (PUCCH) were standardized in Rel-17, in which the mTRP-based transmission included an mTRP transmission based on a single downlink control information (sDCI) and an mTRP transmission based on multiple DCIs (mDCI).

It should be noted that the above introduction to the background is merely provided for clear and complete explanation of the technical solutions of this disclosure and for easy understanding by those skilled in the art. And it should not be understood that these technical solutions are known to those skilled in the art simply because they are described in the background of this disclosure.

### SUMMARY

In a scenario where the unified TCI in Rel-17 targets a single transmission and reception point (sTRP), a network device configures M (M≥1) TCI states for a terminal equipment using RRC signaling, and activates N (1≤N≤M) TCI states among the M TCI states using medium access control (MAC) control element (CE), and indicates L (1≤L≤N) TCI states among the N TCI states using downlink control information (DCI). The transmission configuration indication (TCI) field in a DCI format 1_1 or DCI format 1_2 indicates one or more TCI states. In addition, the DCI format 1_1 or DCI format 1_2 may schedule downlink data, known as DCI format 1_1/1_2 with DL assignment, or may not schedule downlink data, known as DCI format 1_1/1_2 without DL assignment.

A TCI state (referred to as TCI) may include or correspond to one or two source reference signals (source RS). The source reference signal may provide quasi co-location (QCL) information for downlink reception, known as a downlink source reference signal. The source reference signal may provide a reference for an uplink transmission spatial filter (UL TX spatial filter), known as an uplink source reference signal. The source reference signal may provide beam information for a destination channel/signal. For example, a beam used by the terminal equipment to receive the destination channel/signal is the same as a beam used to receive the downlink source reference signal. For another example, a beam used by the terminal equipment to transmit the destination channel/signal is the same as a beam used to transmit the uplink source reference signal. For another example, a beam used by the terminal equipment to transmit the destination channel/signal has reciprocity with a beam used to receive the downlink source reference signal, that is, the beams in opposite directions are used.

Therefore, an indication or update of the TCI state actually includes an indication or update of the beam used by the terminal equipment. The TCI state includes: a joint TCI state, a downlink TCI state (DL only TCI state) and an uplink TCI state (UL only TCI state). The source reference signal included in the downlink TCI state is the downlink source reference signal, the source reference signal included in the uplink TCI state is the uplink source reference signal, and the source reference signal included in the joint TCI state is both the downlink source reference signal and the uplink source reference signal. The joint TCI state acts on both a downlink beam (receiving beam) and an uplink beam (transmitting beam). In other words, the downlink beam and the uplink beam use a same beam, but have opposite beam directions, that is, reciprocity exists between the uplink and downlink beams. The downlink TCI state only affects the downlink beam. The uplink TCI state only affects the uplink beam. The uplink beam is also known as the uplink transmission spatial filter. A TCI field may indicate the joint TCI state (joint DL/UL TCI), or a TCI field may indicate the downlink TCI state and/or the uplink TCI state (separate DL/UL TCI). These two modes may be configured by RRC signaling. For the unified TCI in Rel-17, one TCI field indicates one joint TCI state, or indicates one downlink TCI state, or indicates one uplink TCI state, or indicates one downlink TCI state and one uplink TCI state. The TCI state indicated by one DCI is valid for a period of time until another DCI indicates an updated TCI state. This period of time is called an application time of the TCI state.

Multiple transmission and reception point (mTRP) is an important scenario of a 5G NR system, and can achieve the purpose of increasing throughput or improving reliability through mTRP-based transmission. An mTRP-based transmission of a PDSCH is standardized in Rel-16, and mTRP-based transmissions of a PDCCH, a PUSCH and a PUCCH are standardized in Rel-17. In addition, the mTRP-based transmission in the current Rel-17 includes an mTRP transmission based on a single DCI (sDCI) and an mTRP transmission based on multiple DCIs (mDCI). For sDCI mTRP, one DCI schedules uplink and downlink transmissions of two TRPs, which is suitable for a situation where backhaul between TRPs is ideal; for mDCI mTRP, the two TRPs use two DCIs to schedule uplink and downlink transmissions of respective TRP, respectively, which is suitable for a situation where the backhaul between the TRPs is not ideal.

However, the inventor discovered that for Rel-18, when the UL DCI and the PUSCH scheduled by the UL DCI were located in different application times, respectively, how to determine the UL TCI state and the SRS resource set associated with the PUSCH, and how to transmit the PUSCH based on the UL TCI state and the SRS resource set determined were problems that needed to be solved.

To address at least one of the above problems, embodiments of this disclosure provide an uplink data transmitting method and device, and an uplink data receiving device and method. A terminal equipment determines relevant parameters for uplink data transmission within a second application time based on one or more parameters indicated by third downlink control information and/or at least one uplink transmission configuration indication state (UL TCI state) corresponding to the second application time. Therefore, ambiguity can be avoided in the use of relevant parameters for uplink data transmission, so as to avoid a resulting failure in uplink data transmission.

According to an aspect of the embodiments of this disclosure, there is provided an uplink data transmitting method, applied to a terminal equipment, wherein the terminal equipment is configured with two SRS resource sets. The method includes:
receiving, by the terminal equipment, third downlink control information for scheduling uplink data within a first application time, wherein at least part of the uplink data is within a second application time; and
determining, by the terminal equipment, based on one or more parameters indicated by the third downlink control information and/or at least one uplink transmission configuration indication state (UL TCI state) corresponding to the second application time, to perform an uplink data transmission based on a single transmission and reception point (sTRP) or an uplink data transmission based on multiple transmission and reception points (mTRP) for uplink data within the second application time.

According to another aspect of the embodiments of this disclosure, there is provided an uplink data transmitting method, applied to a terminal equipment, wherein the terminal equipment is configured with two SRS resource sets. The method includes:
receiving, by the terminal equipment, third downlink control information for scheduling uplink data within a first application time, wherein the uplink data is to be transmitted by the terminal equipment within the first application time; and
determining, by the terminal equipment, based on at least one of an SRS resource set, an SRS resource, or a TPMI indicated by the third downlink control information, to perform an uplink data transmission based on a single transmission and reception point (sTRP) or perform an uplink data transmission based on multiple transmission and reception points (mTRP) for the uplink data.

According to another aspect of the embodiments of this disclosure, there is provided an uplink data transmitting method, applied to a terminal equipment, wherein the terminal equipment is configured with two SRS resource sets. The method includes:
receiving, by the terminal equipment, third downlink control information for scheduling uplink data within a first application time, wherein at least part of the uplink data is within a second application time; and
transmitting, by the terminal equipment, no uplink data within the second application time.

According to another aspect of the embodiments of this disclosure, there is provided an uplink data receiving method, applied to a network device, wherein the terminal equipment is configured with two SRS resource sets. The method includes:
transmitting, by the network device, third downlink control information for scheduling uplink data to the terminal equipment within a first application time, wherein at least part of the uplink data is within a second application time; and
receiving, by the network device, the uplink data within the second application time, wherein the terminal equipment determines to perform an uplink data transmission based on a single transmission and reception point (sTRP) or perform an uplink data transmission based on multiple transmission and reception points (mTRP) for the uplink data within the second application time, according to one or more parameters indicated by the third downlink control information and/or at least one uplink transmission configuration indication state (UL TCI state) corresponding to the second application time.

According to another aspect of the embodiments of this disclosure, there is provided an uplink data receiving method, applied to a network device, wherein the terminal equipment is configured with two SRS resource sets. The method includes:
transmitting, by the network device, third downlink control information for scheduling uplink data to the terminal equipment within a first application time;
receiving, by the network device, the uplink data within the first application time,
wherein the terminal equipment determines to perform an uplink data transmission based on a single transmission and reception point (sTRP) or perform an uplink data transmission based on multiple transmission and reception points (mTRP) for the uplink data, based on at least one of an SRS resource set, an SRS resource, or a TPMI indicated by the third downlink control information.

According to another aspect of the embodiments of this disclosure, there is provided an uplink data receiving method, applied to a network device, wherein the terminal equipment is configured with two SRS resource sets. The method includes:
transmitting, by the network device, third downlink control information for scheduling uplink data to the terminal equipment within a first application time, wherein at least part of the uplink data is within a second application time; and
receiving, by the network device, no uplink data within the second application time, wherein the terminal equipment does not transmit the uplink data within the second application time.

According to another aspect of the embodiments of this disclosure, there is provided an uplink data transmitting device, configured in a terminal equipment, wherein the terminal equipment is configured with two SRS resource sets. The uplink data transmitting device includes:
a first receiving unit configured to receive third downlink control information for scheduling uplink data within a first application time, in which at least part of the uplink data is within a second application time; and
a first transmitting unit configured to determine to perform an uplink data transmission based on a single transmission and reception point (sTRP) or perform an uplink data transmission based on multiple transmission and reception points (mTRP) for the uplink data within the second application time, according to one or more parameters indicated by the third downlink control information and/or at least one uplink transmission configuration indication state (UL TCI state) corresponding to the second application time.

According to another aspect of the embodiments of this disclosure, there is provided an uplink data transmitting device, configured in a terminal equipment, wherein the terminal equipment is configured with two SRS resource sets. The uplink data transmitting device includes:
a second receiving unit configured to receive third downlink control information for scheduling uplink data within a first application time, wherein the uplink data is to be transmitted by the terminal equipment within the first application time; and
a second transmitting unit configured to determine, based on at least one of an SRS resource set, an SRS resource, or an uplink transmit precoding matrix indicator (TPMI) indicated by the third downlink control information, to perform an uplink data transmission based on a single transmission and reception point (sTRP), or perform an uplink data transmission based on multiple transmission and reception points (mTRP) for the uplink data.

According to another aspect of the embodiments of this disclosure, there is provided an uplink data transmitting device, configured in a terminal equipment, wherein the terminal equipment is configured with two SRS resource sets. The uplink data transmitting device includes:
a third receiving unit configured to receive third downlink control information for scheduling uplink data within a first application time, wherein at least part of the uplink data is within a second application time; and
a third transmitting unit configured to transmit no uplink data within the second application time.

According to another aspect of the embodiments of this disclosure, there is provided an uplink data receiving device, configured in a network device. The uplink data receiving device includes:
a first transmitting unit configured to transmit third downlink control information for scheduling uplink data to a terminal equipment within a first application time, wherein at least part of the uplink data is within a second application time; wherein the terminal equipment is configured with two SRS resource sets; and
a first receiving unit configured to receive the uplink data within the second application time, wherein the terminal equipment determines to perform an uplink data transmission based on a single transmission and reception point (sTRP) or perform an uplink data transmission based on multiple transmission and reception points (mTRP) for the uplink data within the second application time, according to one or more parameters indicated by the third downlink control information and/or at least one uplink transmission configuration indication state (UL TCI state) corresponding to the second application time.

According to another aspect of the embodiments of this disclosure, there is provided an uplink data receiving device, configured in a network device. The uplink data receiving device includes:
a second transmitting unit configured to transmit third downlink control information for scheduling uplink data to a terminal equipment within a first application time; wherein the terminal equipment is configured with two SRS resource sets; and
a second receiving unit configured to receive the uplink data within the first application time,
wherein the terminal equipment determines to perform an uplink data transmission based on a single transmission and reception point (sTRP) or perform an uplink data transmission based on multiple transmission and reception points (mTRP) for the uplink data based on at least one of an SRS resource set, an SRS resource, or a TPMI indicated by the third downlink control information.

According to another aspect of the embodiments of this disclosure, there is provided an uplink data receiving device, configured in a network device. The uplink data receiving device includes:
a third receiving unit configured to transmit third downlink control information for scheduling uplink data to a terminal equipment within a first application time, wherein at least part of the uplink data is within a second application time; wherein the terminal equipment is configured with two SRS resource sets, and
a third transmitting unit configured to receive no uplink data within the second application time within the second application time, wherein the terminal equipment does not transmit the uplink data within the second application time.

One of the advantageous effects of the embodiments of this disclosure is that the terminal equipment determines relevant parameters for uplink data transmission within the second application time based on the parameter indicated by the third downlink control information and/or at least one uplink transmission configuration indication state (UL TCI state) corresponding to the second application time. Therefore, ambiguity can be avoided in the use of relevant parameters for uplink data transmission, so as to avoid a resulting failure in uplink data transmission.

With reference to the following description and drawings, the particular embodiments of this disclosure are disclosed in detail, and the manners in which the principle of this disclosure can be used are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in a same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, or components.

### BRIEF DESCRIPTION OF THE DRAWINGS

Elements and features depicted in one drawing or embodiment of this disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram illustrating a communication system according to an embodiment of this disclosure;

FIG. 2 is a schematic diagram illustrating a signaling transmission process according to an embodiment of this disclosure;

FIG. 3 is another schematic diagram illustrating the signaling transmission process according to an embodiment of this disclosure;

FIG. 4 is a schematic diagram illustrating an uplink data transmitting method according to an embodiment of this disclosure;

FIG. 5 is a schematic diagram illustrating an association between mTRP PUSCH-related parameters according to an embodiment of this disclosure;

FIG. 6 is a schematic diagram illustrating an association between sTRP PUSCH-related parameters according to an embodiment of this disclosure;

FIG. 7 is another schematic diagram illustrating the signaling transmission process according to an embodiment of this disclosure;

FIG. 8 is an example diagram illustrating a method of determining uplink data related parameters in Case 1 of an embodiment of this disclosure;

FIG. 9 is an example diagram illustrating a method of determining uplink data related parameters in Case 2 of an embodiment of this disclosure;

FIG. 10 is an example diagram illustrating a method of determining uplink data related parameters in Case 3 of an embodiment of this disclosure;

FIG. 11 is an example diagram illustrating a method of determining uplink data related parameters in Case 4 of an embodiment of this disclosure;

FIG. 12 is a schematic diagram illustrating a PUSCH transmission according to an embodiment of this disclosure;

FIG. 13 is another schematic diagram illustrating a PUSCH transmission according to an embodiment of this disclosure;

FIG. 14 is another schematic diagram illustrating a PUSCH transmission according to an embodiment of this disclosure;

FIG. 15 is another schematic diagram illustrating a PUSCH transmission according to an embodiment of this disclosure;

FIG. 16 is another schematic diagram illustrating the uplink data transmitting method according to an embodiment of this disclosure;

FIG. 17 is another schematic diagram illustrating the signaling transmission process according to an embodiment of this disclosure;

FIG. 18 is another schematic diagram illustrating the uplink data transmitting method according to an embodiment of this disclosure;

FIG. 19 is another schematic diagram illustrating the signaling transmission process according to an embodiment of this disclosure;

FIG. 20 is a schematic diagram illustrating an uplink data receiving method according to an embodiment of this disclosure;

FIG. 21 is another schematic diagram illustrating the uplink data receiving method according to an embodiment of this disclosure;

FIG. 22 is another schematic diagram illustrating the uplink data receiving method according to an embodiment of this disclosure;

FIG. 23 is a schematic diagram illustrating an uplink data transmitting device according to an embodiment of this disclosure;

FIG. 24 is another schematic diagram illustrating the uplink data transmitting device according to an embodiment of this disclosure;

FIG. 25 is another schematic diagram illustrating the uplink data transmitting device according to an embodiment of this disclosure;

FIG. 26 is a schematic diagram illustrating an uplink data receiving device according to an embodiment of this disclosure;

FIG. 27 is another schematic diagram illustrating an uplink data receiving device according to an embodiment of this disclosure;

FIG. 28 is another schematic diagram illustrating the uplink data receiving device according to an embodiment of this disclosure;

FIG. 29 is a schematic diagram illustrating a composition of a network device according to an embodiment of this disclosure; and

FIG. 30 is a schematic diagram illustrating a terminal equipment according to an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division a plurality of access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and New Radio (NR) in the future, etc., and/or other communication protocols that are currently known or will be developed in the future.

In the embodiments of this disclosure, the term “network device”, for example, refers to a device in a communication system that accesses terminal equipment to the communication network and provides services for the terminal equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, equipment accessing to a communication network and receiving network services via a network device. The terminal equipment may be fixed or mobile, and may also be referred to as a mobile station (MS), a terminal, a subscriber station (SS), an access terminal (AT), and a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal device may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipment described above. “A device” in this text may refer to a network device, and may also refer to a terminal equipment, except otherwise specified.

A scenario of an embodiment in this disclosure shall be described below by way of examples. However, this disclosure is not limited thereto.

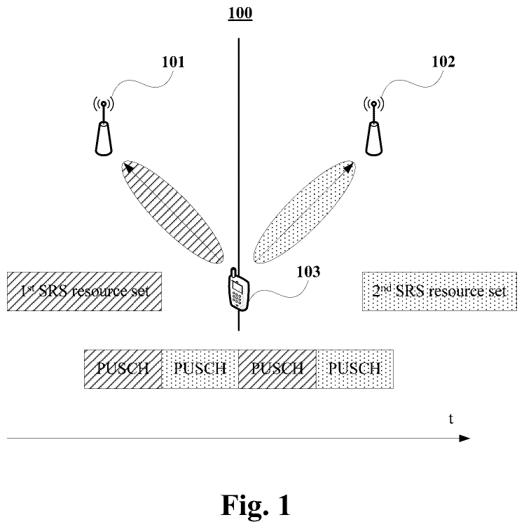

FIG. 1 is a schematic diagram illustrating a communication system according to an embodiment of this disclosure, which schematically illustrates a situation in which a terminal equipment and a network device are used as an example. As illustrated in FIG. 1, a communication system 100 may include a first TRP 101, a second TRP 102, and a terminal equipment 103, in which the first TRP 101 and the second TRP 102 may be network devices. For simplicity, FIG. 1 only illustrates two network devices and one terminal equipment as an example; however, this disclosure is not limited thereto.

In an embodiment of this disclosure, existing services or services that may be implemented in the future may be transmitted between the first TRP 101, the second TRP 102 and the terminal equipment 103. For example, these services may include but are not limited to: an enhanced Mobile Broadband (eMBB), a massive Machine Type Communication (mMTC) and an Ultra-Reliable and Low Latency Communication (URLLC), etc.

An mTRP-based transmission of a PDSCH is standardized in Rel-16, and mTRP-based transmissions of a PDCCH, a PUSCH and a PUCCH are standardized in Rel-17. The mTRP-based transmission includes an mTRP transmission based on a single DCI (sDCI) and an mTRP transmission based on multiple DCIs (mDCI). For sDCI mTRP, one DCI schedules uplink and downlink transmissions of two TRPs, which is suitable for a situation where backhaul between TRPs is ideal. For mDCI mTRP, the two TRPs use two DCIs to schedule uplink and downlink transmissions of respective TRP, respectively, which is suitable for a situation where the backhaul between the TRPs is not ideal.

Taking the terminal equipment 103 transmitting a PUSCH in the mTRP scenario as an example, as illustrated in FIG. 1, the terminal equipment 103 transmits the PUSCH in a manner of PUSCH repetition, e.g., transmits to the first TRP 101 in a time slot 1, transmits to the second TRP 102 in a time slot 2, and so on.

In the mTRP scenario, the terminal equipment is configured with two SRS resource sets corresponding to two TRPs, respectively. For example, the terminal equipment is configured with two SRS resource sets. For example, the terminal equipment 103 is configured with the first SRS resource set (1^{st} SRS resource set) corresponding to the first TRP 101; and configured with the second SRS resource set (2^{nd} SRS resource set) corresponding to the second TRP 102.

Due to a difference in geographical location between the first TRP 101 and the second TRP 102, the terminal equipment may transmit the PUSCH to the first TRP 101 and/or the second TRP 102 based on different transmission parameters such as a pre-coding matrix, an SRS resource indicator (SRI), and a power control parameter, etc. In addition, the terminal equipment obtains transmission parameters for the first TRP 101 and the second TRP 102 based on the first SRS resource set and the second SRS resource set.

Taking the transmission parameter being the SRS resource indicator (SRI) as an example, for a dynamic uplink grant (dynamic UL grant), two SRI fields in the DCI indicate SRS resources in the two SRS resource sets, respectively; and for a configured grant, two SRIs are configured by RRC for the two SRS resource sets. Therefore, the terminal equipment needs to know a mapping relationship between the PUSCH repetition and the SRS resource set, i.e., needs to know on which SRS resource set the transmission of each PUSCH repetition should be based.

The UL DCI that schedules the PUSCH can indicate the terminal equipment to perform sTRP PUSCH transmission or mTRP PUSCH transmission by using “SRS resource set indicator” field. For the sTRP PUSCH transmission, this field can indicate on which of the two SRS resource sets the transmission is based. For the mTRP PUSCH transmission, this field can indicate in which mapping order the two SRS resource sets are mapped to the PUSCH repetition. For example, in an order of “the first SRS resource set, followed by the second SRS resource set” (indicated as #1, #2), the purpose of “transmission to the first TRP 101, followed by transmission to the second TRP 102” is achieved, as illustrated in FIG. 1; alternatively, in an order of “the second SRS resource set, followed by the first SRS resource set” (indicated as #2, #1), the purpose of “transmission to the second TRP 102, followed by transmission to the first TRP 101” is achieved, that is, the mapping order in FIG. 1 is exchanged. In a case where a higher-layer parameter “cyclicMapping” is enabled, mapping to the PUSCH repetition is realized in an order of #1, #2, #1, #2 . . . ; In a case where a higher-layer parameter “sequentialMapping” is enabled, mapping to the PUSCH repetition is realized in an order of #1, #1, #2, #2 . . . .

The unified TCI in Rel-17 is only applicable to an sTRP scenario. Considering the significance of the mTRP, a corresponding unified TCI mechanism needs to be designed for the mTRP scenario. 3GPP standardizes the unified TCI of the mTRP in Rel-18. The unified TCI of the mTRP has been currently determined as one of project proposals for Rel-18, and the standardization of Rel-18 has not yet started. Functionally speaking, the unified TCI of the mTRP can indicate TCI states of two TRPs as required, so as to support the mTRP PUSCH transmission, and can also indicate a TCI state of one TRP, so as to support the sTRP PUSCH transmission.

A description is given below in conjunction with specific uplink and downlink signaling.

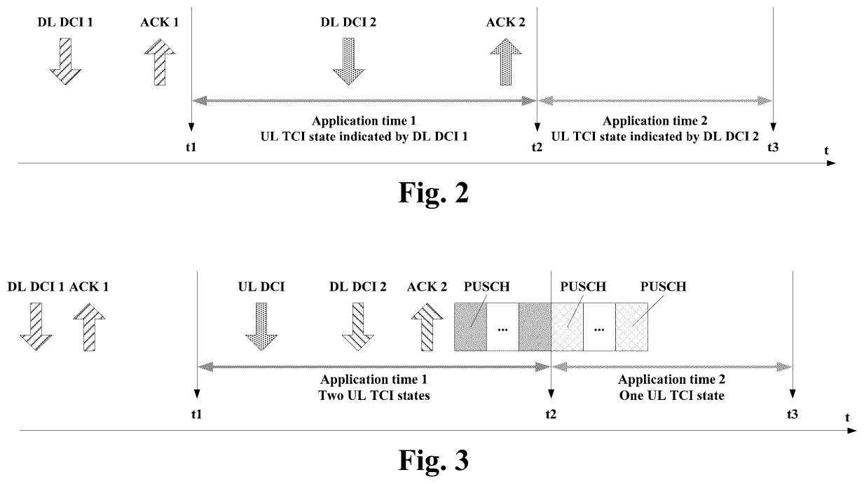

FIG. 2 is a schematic diagram illustrating a signaling transmission process according to an embodiment of this disclosure. For the unified TCI, the DL DCI indicates an application time of at least one UL TCI state, such as a DL DCI 1 or a DL DCI 2 in FIG. 2. The UL TCI state may be indicated by joint DL/UL TCI state or by separate DL/UL TCI state. The terminal equipment receives the DL DCI 1 indicating the at least one UL TCI state, wherein the UL TCI state indicated by the DL DCI 1 is different from the UL TCI state indicated by the previous DL DCI (such as the DL DCI 0, not illustrated in FIG. 2) (including different numbers of UL TCI states). The terminal equipment transmits an ACK (ACK 1) for the DL DCI 1 to the network device. The DL DCI 1 may be a DCI format that schedules the PDSCH, or a DCI format that does not schedule the PDSCH (DCI format without DL assignment). A first slot to apply the UL TCI state indicated by the DL DCI 1 is a first slot after Y symbols following a last symbol of the ACK1, and a moment in which this slot starts is denoted as t1. Assuming that the DL DCI 2 is a first DL DCI that indicates a UL TCI state different from the UL TCI state indicated by the DL DCI 1 after the DL DCI 1, a first slot to apply the UL TCI state indicated by the DL DCI 2 may be determined in a same method, and a moment in which this slot starts is denoted as t2. The application time of the UL TCI state indicated by the DL DCI 1 (a first application time: an application time 1) includes all slots between t1 and t2. In other words, the UL TCI state effective within the application time 1 is indicated by the DL DCI 1. Similarly, the application time of the UL TCI state indicated by the DL DCI 2 (a second application time: an application time 2) may be represented as all slots between t2 and t3, where the t3 corresponds to a first slot to apply a UL TCI state different from the UL TCI state indicated by the DL DCI 2, the different UL TCI state is indicated by a DL DCI 3 (not illustrated in FIG. 2) located after the DL DCI 2. To avoid an out-of-order situation for a downlink HARQ, for the DL DCI 2 located after the DL DCI 1, the associated ACK 2 is located after the ACK 1 other than before the ACK 1.

For the PUSCH scheduled by the UL DCI in the sDCI mTRP scenario, the terminal equipment configured with two SRS resource sets may determine the UL TCI state and the SRS resource set used by the PUSCH in the method: the UL TCI state used by the PUSCH is the UL TCI state (i.e., using a latest UL TCI state) of the PUSCH within the application time, the SRS resource set used by the PUSCH is indicated by an SRS resource set indicator field of the UL DCI (i.e., the UL DCI can indicate a handover between different PUSCH schemes, such as a handover between the sTRP PUSCH and the mTRP PUSCH). However, when the UL DCI and the PUSCH scheduled by the UL DCI are located in different application times, respectively, the UL TCI state and the SRS resource set determined in the above method conflict with each other, such that an ambiguity in the use of UL TCI state and SRS resource set exists, which in turn results in a failure in PUSCH transmission.

FIG. 3 schematically illustrates the aforementioned problem. FIG. 3 is another schematic diagram illustrating the signaling transmission process according to an embodiment of this disclosure, and similarities to FIG. 2 will not be described again. As illustrated in FIG. 3, two UL TCI states are scheduled within the application time 1 of the DL DCI 1, one UL TCI state is scheduled within the application time 2 of the DL DCI 2, and at least one PUSCH transmission is scheduled by one UL DCI within the application time 1, the UL DCI is located within the application time (application time 1) of two UL TCI states, and at least one PUSCH is located within the application time (application time 2) of one UL TCI state. The following PUSCH refers to a PUSCH within the application time 2. At a scheduling moment of the UL DCI, the number of the UL TCI states is 2. The network device cannot predict that the UL TCI states may change to 1 in the future (t2 moment). For example, a URLLC service suddenly needs to be scheduled by the DL DCI 2, and the DL DCI 2 can take an opportunity to indicate the updated UL TCI state. Therefore, the SRS resource set indicator field of the UL DCI is still determined based on an assumption of two UL TCI states. Assuming that the SRS resource set indicator field indicates that the terminal equipment uses two SRS resource sets that share a one-to-one correspondence with the two UL TCI states. Consequences are generated using the aforementioned method: the PUSCH uses 1 UL TCI state within the application time 2, and uses 2 SRS resource sets indicated by the UL DCI. In this case, the number of UL TCI states does not match the number of SRS resource sets. Since the PUSCH transmission based on the 1 UL TCI state only requires one SRS resource set, on the one hand, the aforementioned method produces a misconfigured or undefined behavior, such that the terminal equipment does not know how to transmit the PUSCH; on the other hand, based on which SRS resource set for the PUSCH transmission, the aforementioned method cannot enable the terminal equipment and the network device to have a same understanding. If the understanding between two parties is inconsistent, demodulation of the PUSCH fails.

Therefore, when the UL DCI and the PUSCH scheduled by the UL DCI are located in different application times, respectively, how to determine the UL TCI state and the SRS resource set associated with the PUSCH, and how to transmit the PUSCH based on the UL TCI state and the SRS resource set determined, are problems to be solved as needed.

To address at least one of the above problems, embodiments of this disclosure provide an uplink data transmitting device and method, and an uplink data receiving device and method.

### Embodiments of a First Aspect

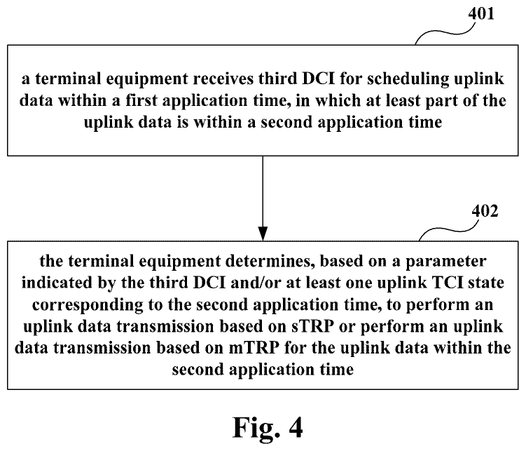

The embodiments of this disclosure provide an uplink data transmitting method, applied to a terminal equipment. The terminal equipment is configured with two SRS resource sets. FIG. 4 is a schematic diagram illustrating an uplink data transmitting method according to an embodiment of this disclosure. As illustrated in FIG. 4, the method includes:
401: a terminal equipment receives third downlink control information for scheduling uplink data within a first application time, at least part of the uplink data is within a second application time; and
402: the terminal equipment determines, based on one or more parameters indicated by the third downlink control information and/or at least one uplink transmission configuration indication state (UL TCI state) corresponding to the second application time, to perform an uplink data transmission based on a single transmission and reception point (sTRP) or perform an uplink data transmission based on multiple transmission and reception points (mTRP) for the uplink data within the second application time.

It is worth noting that the FIG. 4 only schematically illustrates an embodiment of this disclosure, taking a terminal equipment as an example, however, this disclosure is not limited thereto. For example, an order of execution of the operations may be appropriately adjusted, and furthermore, some other operations may be added, or some operations therein may be reduced. In addition, the objects of the operations can also be adjusted. And appropriate variants may be made by those skilled in the art according to the above content, without being limited to what is contained in the FIG. 4.

In some embodiments, the terms “TRP” and “SRS resource set” may be used interchangeably. The terms “TRP” and “CSI-RS resource set” may be used interchangeably. The wordings “corresponding”, “associated” and “comprising” may be used interchangeably. The terms “uplink TCI state” and “joint TCI state” may be used interchangeably. The terms “PUSCH”, “PUSCH transmission” and “PUSCH transport” may be used interchangeably. The term “DL TCI state” or “UL TCI state” may be indicated by “joint DL/UL TCI state” or “separate DL/UL TCI state”. The term “DL TCI state” may be “DL only TCI state” or “joint TCI state”. The term “UL TCI state” may be “UL only TCI state” or “joint TCI state”. “TPMI” refers to information indicated by a “precoding information and number of layers” field or a “second precoding information” field in the DCI, including information on the pre-coding matrix and information on the number of layers. The fields may be referred to as “TPMI fields”. The above disclosure only illustrates the embodiments. However, the embodiments of this disclosure are not limited thereto.

Thus, the terminal equipment determines relevant parameters for uplink data transmission within the second application time on the basis of the parameter indicated by the third downlink control information and/or at least one uplink transmission configuration indication state (UL TCI state) corresponding to the second application time. Therefore, ambiguity can be avoided in the use of relevant parameters for uplink data transmission, so as to avoid a resulting failure in uplink data transmission.

In some embodiments, the terminal equipment receives first downlink control information corresponding to the first application time; and receives second downlink control information corresponding to the second application time within the first application time.

For example, the first downlink control information is the DL DCI 1 as illustrated in FIG. 2, and the first application time is an application time of the UL TCI state indicated by the DL DCI 1 (such as the application time 1); the second downlink control information is the DL DCI 2 as illustrated in FIG. 2, and the second application time is an application time of the UL TCI state indicated by the DL DCI 2 (such as the application time 2).

In some embodiments, the second downlink control information indicates at least one uplink transmission configuration indication state (UL TCI state) corresponding to the second application time.

For example, the DL DCI 2 as illustrated in FIG. 3 indicates one UL TCI state, of which an application time is the application time 2. Alternatively, the DL DCI 2 may also indicate two UL TCI states (not illustrated in FIG. 3).

In some embodiments, the third downlink control information may be the UL DCI, also referred to as uplink grant (UL grant).

For example, the third downlink control information may be the UL DCI as illustrated in FIG. 3. For example, the third downlink control information also includes one or more parameters required for the scheduled uplink data. For example, the parameters include at least one of an SRS resource set, an SRS resource, or an uplink transmit precoding matrix indicator (TPMI). In some embodiments, the parameters are indicated by at least one of the SRS resource set indicator field, the SRI field or the TPMI field in the third downlink control information.

In some embodiments, the uplink data includes at least one of uplink data types: an uplink repetition (PUSCH repetition) type A; an uplink repetition (PUSCH repetition) type B; or a PUSCH transmitted by a plurality of panels simultaneously.

In some embodiments, for the sDCI mTRP scenario, the PUSCH may be one PUSCH or may be PUSCH repetition.

For example, refer to relevant parts of standard TS 38.214 V17.1.0 for specific transmissions of the PUSCH repetition type A and the PUSCH repetition type B, which is not limited in this disclosure.

In some embodiments, the mTRP PUSCH is equivalent to the PUSCH based on two SRS resource sets, or the PUSCH based on two UL TCI states.

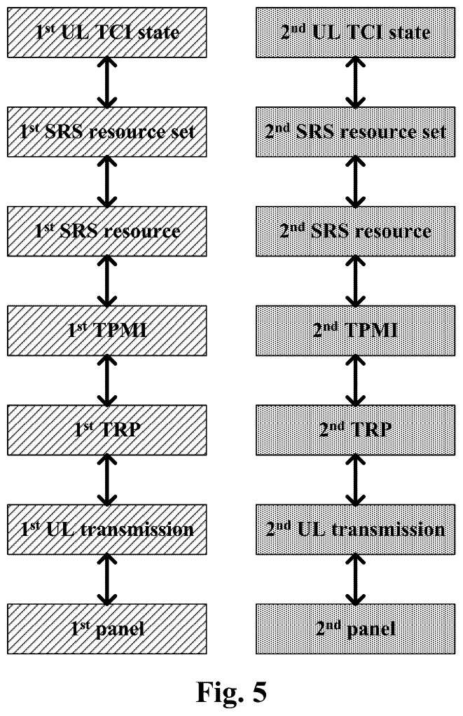

FIG. 5 is a schematic diagram illustrating an association between mTRP PUSCH-related parameters according to an embodiment of this disclosure.

For the mTRP PUSCH, taking two TRPs as an example, the terminal equipment performs an uplink transmission (UL transmission) to the two TRPs, which is schematically illustrated in FIG. 5. Two uplink transmissions may belong to two PUSCH repetitions (corresponding to two redundancy versions (RV)). For example, the terminal equipment transmits the PUSCH repetitions to the two TRPs in a time division multiplexing manner, i.e., the mTRP PUSCH of Rel-17. In addition, the mTRP PUSCH to be standardized by Rel-18 may also be referred to as a simultaneous multi-panel UL transmission (STxMP). The terminal equipment may simultaneously transmit the PUSCH (also known as the PUSCH transmitted by a plurality of panels simultaneously) to the two TRPs by using two panels in a manner of frequency division multiplexing or space division multiplexing or single frequency network (SFN). That is, two uplink transmissions may belong to one PUSCH (corresponding to one RV) or two PUSCH repetitions (corresponding to two RVs). For example, the mTRP PUSCH of Rel-18 may also be referred to as a PUSCH based on two panels. This disclosure is applicable to all forms of mTRP PUSCH mentioned above.

FIG. 5 illustrates the association among the UL TCI state, the panel, the uplink transmission, the TRP, the SRS resource sets, the SRS resource and the TPMI. One TRP is associated with one SRS resource set, one UL TCI state, one SRS resource, one TPMI, or one uplink transmission. For the mTRP PUSCH in Rel-18, one panel may be associated with one TRP, and then associated with one SRS resource set, one UL TCI state, one SRS resource, one TPMI, or one uplink transmission. One TRP may be equivalent to one SRS resource set, and one panel may be equivalent to one SRS resource set based on the association.

In some embodiments, the sTRP PUSCH refers to an sTRP PUSCH performed by the terminal equipment configured with two SRS resource sets, the sTRP PUSCH is equivalent to a PUSCH based on one SRS resource set, or a PUSCH based on one UL TCI state.

In some embodiments, the terminal equipment receives the DL DCI indicating one UL TCI state, and performs the sTRP PUSCH transmission using the UL TCI state.

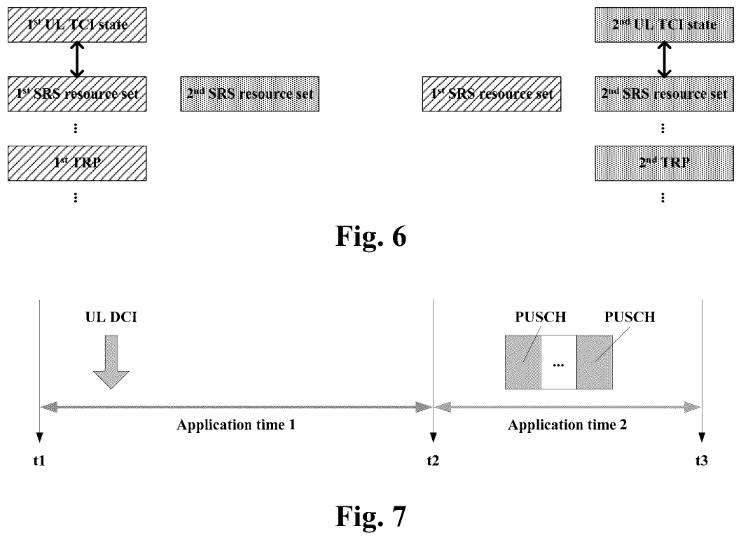

FIG. 6 is a schematic diagram illustrating an association between sTRP PUSCH-related parameters according to an embodiment of this disclosure.

For the sTRP PUSCH, the terminal equipment performs an uplink transmission to one of the two TRPs, which is schematically illustrated in FIG. 6. For the terminal equipment configured with two SRS resource sets, dynamic switching may be performed between the sTRP PUSCH and the mTRP PUSCH. For example, the UL DCI indicates one or two SRS resource sets, which represents the sTRP PUSCH transmission or the mTRP PUSCH transmission, respectively. For example, the DL DCI indicates one or two UL TCI states, which represents the sTRP PUSCH transmission or the mTRP PUSCH transmission, respectively. As illustrated in FIG. 6, the terminal equipment may perform an uplink transmission to the first TRP, and use the SRS resource set, the UL TCI state, the SRS resource and the TPMI associated with the first TRP; the terminal equipment may perform an uplink transmission to the second TRP, and use the SRS resource set, the UL TCI state, the SRS resource, and the TPMI associated with the second TRP. The uplink transmission may be one PUSCH repetition or PUSCH repetition.

FIG. 7 is another schematic diagram illustrating the signaling transmission process according to an embodiment of this disclosure.

A description is given below by taking FIG. 7 as an example. Without loss of generality, the figure only illustrates the application time 1 (first application time), the application time 2 (second application time), the UL DCI located within the application time 1, and the PUSCH located within the application time 2.

For example, the terminal equipment is configured with two SRS resource sets. The UL TCI state in effect within the application time 1 may be one or two. Given that the UL TCI state is known, the SRS resource set indicated by the UL DCI may be 1 or 2 corresponding to 1 or 2 UL TCI states, respectively. The UL TCI state in effect within the application time 2 may be 1 or 2, and is different from the UL TCI state within the application time 1. Table 1 lists all possible combinations of UL TCI states within different application times, including Case 1 to Case 4. The UL TCI state within the application time 2 is different from the UL TCI state within the application time 1. From the application time 1 to the application time 2, the number of UL TCI states has changed for the Cases 1 and 2, and the number of UL TCI states has not changed for Cases 3 and 4. The UL DCI indicates the SRS resource set, the SRS resource and the TPMI according to the UL TCI state within the application time 1.

TABLE 1
Possible combinations of UL TCI states
within different application times

| | Application time 1 | Application time 2 |
|---|---|---|
| Case 1 | UL TCI state 1-1, UL | UL TCI state 1-2 |
| | TCI state 2-1 | |
| Case 2 | UL TCI state 1-1 | UL TCI state 1-2, UL |
| | | TCI state 2-2 |
| Case 3 | UL TCI state 1-1, UL | UL TCI state 1-2, UL |
| | TCI state 2-1 | TCI state 2-2 |
| Case 4 | UL TCI state 1-1 | UL TCI state 1-2 |

In some embodiments, for the uplink data within the first application time and/or the uplink data within the second application time, at least the following information needs to be determined: the uplink data transmission based on the sTPR PUSCH or the uplink data transmission based on the mTRP PUSCH; the number of UL TCI states used by the uplink data and the specific UL TCI state; the specific parameters for uplink data transmission, such as at least one of the SRS resource set, the SRS resource, or the uplink transmit precoding matrix indicator (TPMI).

In some embodiments, the uplink data within the second application time is transmitted using part or all of the uplink transmission configuration indication states (UL TCI states) in at least one uplink transmission configuration indication state (UL TCI state) corresponding to the second application time.

In some embodiments, in a case where the parameters indicated by the third downlink control information include one SRS resource set, the uplink data transmission based on a single transmission and reception point (sTRP) (sTRP PUSCH) is performed for the uplink data within the second application time; and in a case where the parameters include more than one SRS resource set, the uplink data transmission based on multiple transmission and reception points (mTRP) (mTRP PUSCH) is performed for the uplink data within the second application time.

For example, the terminal equipment determines to perform the sTRP PUSCH transmission or the mTRP PUSCH transmission within the second application time based on at least one of the SRS resource set, the SRS resource, or the TPMI indicated by the UL DCI.

For example, in a case where the UL DCI indicates two SRS resource sets, two SRS resources and two TPMIs, the terminal equipment performs the mTRP PUSCH transmission within the second application time; and in a case where the UL DCI indicates one SRS resource set, one SRS resource, and one TPMI, the terminal equipment performs the sTRP PUSCH transmission within the second application time.

For example, as shown in the Case 1, although the number of UL TCI states has changed from two within the application time 1 to one within the application time 2, since the UL DCI indicates the mTRP PUSCH transmission according to the application time 1, the terminal equipment still performs the mTRP PUSCH transmission within the application time 2 without switching to the sTRP PUSCH transmission. As shown in the Case 2, although the number of UL TCI states has changed from one within the application time 1 to two within the application time 2, since the UL DCI indicates the sTRP PUSCH transmission according to the application time 1, the terminal equipment still performs the sTRP PUSCH transmission within the application time 2 without switching to the mTRP PUSCH transmission.

In some embodiments, the uplink data within the second application time is transmitted using the uplink transmission configuration indication state (UL TCI state) associated with the parameters indicated by the third downlink control information in at least one uplink transmission configuration indication state (UL TCI state) corresponding to the second application time, or using a predefined uplink transmission configuration indication state (UL TCI state) in at least one uplink transmission configuration indication state (UL TCI state) corresponding to the second application time.

In some embodiments, the predefined uplink transmission configuration indication state (UL TCI state) is one uplink transmission configuration indication state (UL TCI state) in a specific position in at least one uplink transmission configuration indication state (UL TCI state) corresponding to the second application time.

In some embodiments, the terminal equipment uses part or all of the UL TCI states within the second application time, in the second application time.

For example, for the Case 2, the terminal equipment determines to perform the sTRP PUSCH transmission within the application time 2 based on the SRS resource set, the SRS resource and the TPMI indicated by the UL DCI. Two UL TCI states are available within the application time 2. The terminal equipment performs the sTRP PUSCH transmission using one of the UL TCI states.

For example, for the Cases 3 and 4, the number of UL TCI states within the application time 1 and the application time 2 is the same. Regardless of based on the UL DCI or based on the UL TCI state within the application time 2, the PUSCH transmission (sTRP PUSCH or mTRP PUSCH) within the application time 2 determined by the terminal equipment is the same as the PUSCH transmission within the application time 1, thus all the UL TCI states within the application time 2 are used.

In some embodiments, the terminal equipment uses part of the UL TCI states within the second application time, in the second application time, and the terminal equipment determines the UL TCI states according to one of:
a UL TCI state associated with the SRS resource set; and
a default (predefined) UL TCI state.

For example, two UL TCI states are available within the second application time, and the terminal equipment determines to use the second SRS resource set within the second application time. For example, the UL DCI indicates the “second SRS resource set” that is associated with the second UL TCI state, then uses the UL TCI state associated with the “second SRS resource set”, i.e., the second UL TCI state.

For example, the terminal equipment uses the default (predefined) UL TCI state, that is, the first UL TCI state of the two UL TCI states.

In some embodiments, at least one of information in the parameter: the SRS resource set, the SRS resource, or the TPMI is used to transmit the uplink data within the second application time.

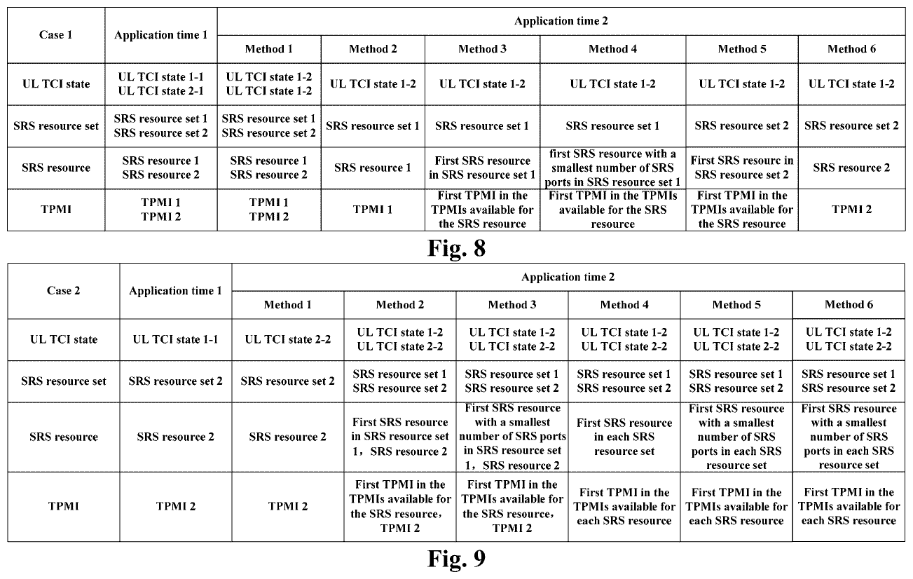

For example, how the Cases 1-4 use at least one of information in the parameter: the SRS resource set, the SRS resource, or the TPMI to transmit the uplink data within the second application time will be described subsequently. For example, refer to the method 1 in FIGS. 8-11.

In some embodiments, at least one of the SRS resource set, the SRS resource, or the TPMI is indicated by the SRS resource set indicator field of the UL DCI.

For example, the SRS resource set indicator field of the UL DCI includes two bits to indicate the SRS resource set, the SRS resource and the TPMI used according to Table 2 below. The SRS resource set indicator field indicates the SRS resource set used and the SRI field and the TPMI field associated therewith. The SRI field and the TPMI field indicate the SRS resource and the TPMI, respectively.

TABLE 2
SRS resource set indicator fields

| Bit | |
|---|---|
| fields | SRS resource set, SRS resource, TPMI |
| 00 | The first SRS resource set is used, the first SRI |
| | field and the first TPMI field are associated |
| | with the first SRS resource set, and the second |
| | SRI field and the second TPMI field are |
| | reserved. |
| 01 | The second SRS resource set is used, the first SRI |
| | field and the first TPMI field are associated |
| | with the second SRS resource set, and the second |
| | SRI field and the second TPMI field are reserved. |
| 10 | Two SRS resource sets are used, the first SRI |
| | field and the first TPMI field are associated with |
| | the first SRS resource set, and the second SRI |
| | field and the second TPMI field are associated with |
| | the second SRS resource set. The two SRS resource sets |
| | are mapped to the PUSCH repetition in an order of |
| | “the first SRS resource set, followed by the |
| | second SRS resource set”. |
| 11 | Two SRS resource sets are used, the first SRI |
| | field and the first TPMI field are associated with the |
| | first SRS resource set, and the second SRI field and the second |
| | TPMI field are associated with the second SRS resource set. |
| | The two SRS resource sets are mapped to the PUSCH repetition |
| | in an order of “the second SRS resource set, followed by |
| | the first SRS resource set”. |

In some embodiments, in a case where the uplink transmission configuration indication state (UL TCI state) corresponding to the second application time includes one uplink transmission configuration indication state (UL TCI state), the uplink data transmission based on the single transmission and reception point (sTRP) (sTRP PUSCH) is performed for the uplink data within the second application time; and in a case where the uplink transmission configuration indication state corresponding to the second application time includes more than one uplink transmission configuration indication state (UL TCI state), the uplink data transmission based on the multiple transmission and reception points (mTRP) (mTRP PUSCH) is performed for the uplink data within the second application time.

In some embodiments, the uplink data within the second application time is transmitted using at least one uplink transmission configuration indication state (UL TCI state) corresponding to the second application time.

In some embodiments, the terminal equipment determines that the sTRP PUSCH transmission or the mTRP PUSCH transmission is performed within the second application time based on the UL TCI state within the second application time.

For example, in a case where two UL TCI states are available within the second application time, the terminal equipment performs the mTRP PUSCH transmission; and in a case where one UL TCI state is available within the second application time, the terminal equipment performs the sTRP PUSCH transmission.

For example, as shown in the Case 1, if the number of UL TCI states changes from two within the application time 1 to one within the application time 2, the terminal equipment switches to the sTRP PUSCH transmission within the application time 2. As shown in the Case 2, if the number of UL TCI states changes from one within the application time 1 to two within the application time 2, the terminal equipment switches to the mTRP PUSCH transmission within the application time 2.

A brief introduction to “at least one of information included in the parameter indicated by the third downlink control information and/or predefined: the SRS resource set, the SRS resource, or the TPMI” is given below. For the Cases 1-4, how to use at least one of information included in the parameter indicated by the third downlink control information and/or predefined: the SRS resource set, the SRS resource, or the TPMI, to transmit the uplink data within the second application time will be described subsequently. For example, a method other than the method 1 in FIGS. 8-11 can be seen.

In some embodiments, at least one of information included in the parameter indicated by the third downlink control information and/or predefined: the SRS resource set, the SRS resource, or the TPMI is used to transmit the uplink data within the second application time.

In some embodiments, the at least one of the predefined information: the SRS resource set, the SRS resource, or the TPMI is determined according to one of:
two configured SRS resource sets;
one SRS resource set in a specific position in the two configured SRS resource sets;
one SRS resource in a specific position in at least one SRS resource within one SRS resource set;
a first SRS resource with a smallest number of SRS ports in at least one SRS resource in one SRS resource set;
one TPMI in a specific position in at least one TPMI available for one SRS resource.

For example, the SRS resource set, the SRS resource or the TPMI used by the terminal equipment within the second application time are determined according to one of:
the SRS resource set, the SRS resource or the TPMI indicated by the UL DCI; and
the default (predefined) SRS resource set, SRS resource or TPMI.

For example, the terminal equipment determines to perform the sTRP PUSCH transmission or the mTRP PUSCH transmission within the second application time based on the UL TCI state within the second application time, and uses the SRS resource set, the SRS resource, and the TPMI indicated by the UL DCI within the second application time.

For example, the terminal equipment determines to perform the sTRP PUSCH transmission or the mTRP PUSCH transmission within the second application time based on the UL TCI state within the second application time, and uses the default (predefined) SRS resource set, SRS resource and TPMI within the second application time.

For example, the terminal equipment determines one or two SRS resource sets used within the second application time. For example, in a case of one UL TCI state, one SRS resource set is used; in a case of two UL TCI states, two SRS resource sets are used. Examples are merely provided here for illustration purposes. Refer to the subsequent methods in the Cases 1-4 for how to determine the SRS resource sets. For any SRS resource set, if the UL DCI indicates the SRS resource and the TPMI associated therewith, the SRS resource and the TPMI indicated by the UL DCI are used. If the UL DCI does not indicate the SRS resource and the TPMI associated therewith, the default (predefined) SRS resource and TPMI are used.

In some embodiments, the two default (predefined) SRS resource sets are two configured SRS resource sets.

For example, the terminal equipment performs the mTRP PUSCH transmission within the second application time and uses the two default (predefined) SRS resource sets. These two default (predefined) SRS resource sets are two SRS resource sets configured by RRC signaling for the mTRP PUSCH transmission.

In some embodiments, one default (predefined) SRS resource set is the first or second SRS resource set in the two configured SRS resource sets.

For example, the terminal equipment performs the sTRP PUSCH transmission within the second application time and uses the one default (predefined) SRS resource set. The default (predefined) SRS resource set is the first SRS resource set of the two configured SRS resource sets.

In some embodiments, the one default (predefined) SRS resource is the first SRS resource in the SRS resource set.

For example, the terminal equipment performs the sTRP PUSCH transmission or the mTRP PUSCH transmission based on one SRS resource set or two SRS resource sets within the second application time, and uses one default (predefined) SRS resource in each SRS resource set. The default (predefined) SRS resource is the first SRS resource in the SRS resource set.

In some embodiments, the one default (predefined) SRS resource is a first SRS resource with a smallest number of SRS ports in the SRS resource set.

For example, the terminal equipment performs the sTRP PUSCH transmission or the mTRP PUSCH transmission based on one SRS resource set or two SRS resource sets within the second application time, and uses one default (predefined) SRS resource in each SRS resource set. The default (predefined) SRS resource is the SRS resource with the smallest number of SRS ports in the SRS resource set. When a plurality of SRS resources with the smallest number of SRS ports are available, the default (predefined) SRS resource is the first SRS resource in the plurality of SRS resources with the smallest number of SRS ports.

In some embodiments, the one default (predefined) TPMI is the first TPMI of the TPMIs available for the SRS resource.

For example, the terminal equipment performs the sTRP PUSCH transmission or the mTRP PUSCH transmission based on one SRS resource or two SRS resources within the second application time. One default (predefined) TPMI is associated with each SRS resource. A plurality of TPMIs (including the number of layers and precoding matrix information) available for the SRS resource may be determined according to the number of SRS ports of the SRS resource and other configured parameters. The default (predefined) TPMI is the first TPMI among all available TPMIs.

In some embodiments, at least one of information associated with the uplink transmission configuration indication state (UL TCI state) within the second application time: the SRS resource set, the SRS resource, or the TPMI, is used to transmit the uplink data within the second application time.

For example, one UL TCI state (UL TCI state X) is available within the second application time, thus the terminal equipment determines to perform the sTRP PUSCH transmission within the second application time. The terminal equipment determines one SRS resource set associated with the UL TCI state X. For example, if the source reference signal contained in the UL TCI state X is one SRS resource that belongs to a SRS resource set (SRS resource set A), the SRS resource set associated with the UL TCI state X is the SRS resource set A. For another example, the UL DCI has indicated the terminal equipment to transmit the PUSCH using the SRS resource set A within the application time of the UL TCI state X, then the SRS resource set associated with the UL TCI state X is the SRS resource set A. The terminal equipment transmits the PUSCH using the SRS resource set A. The SRS resource and the TPMI used by the terminal equipment may be obtained according to any of the aforementioned methods. For example, two UL TCI states (a UL TCI state 1-2 and a UL TCI state 2-2) are available within the second application time, thus the terminal equipment determines to perform the mTRP PUSCH transmission within the second application time. Since the SRS resource set 1 and the SRS resource set 2 are associated with the UL TCI state 1-2 and the UL TCI state 2-2, respectively, the terminal equipment transmits the PUSCH using the SRS resource set 1 and the SRS resource set 2. The SRS resource and the TPMI used by the terminal equipment may be obtained according to any of the aforementioned methods.

Determination of uplink data related parameters for each Case is described below in examples.

The method of determining the UL TCI state, the SRS resource set, the SRS resource and the TPMI for the Cases 1-4 can use any combination of the aforementioned methods, which is schematically described below.

Case 1: 2 UL TCI states are available within the application time 1, the UL DCI indicates 2 SRS resource sets, and 1 UL TCI state is available within the application time 2.

FIG. 8 is an example diagram illustrating a method of determining uplink data related parameters in Case 1 of an embodiment of this disclosure. FIG. 8 schematically illustrates the method of determining the UL TCI state, the SRS resource set, the SRS resource and the TPMI for the PUSCH within the application time 2 for the Case 1.

In some embodiments, in a case where one UL TCI state is available within the second application time, the terminal equipment performs the mTRP PUSCH transmission within the second application time, and the UL TCI state associated with the first SRS resource set is one UL TCI state within the second application time, and the UL TCI state associated with the second SRS resource set is one UL TCI state within the second application time.

In some embodiments, the terminal equipment performs the mTRP PUSCH transmission based on two SRS resource sets according to the parameters indicated by the third downlink control information within the second application time, and one UL TCI state is available within the second application time. In this case, the one UL TCI state is associated with the two SRS resource sets.

For the method 1, the PUSCH uses two SRS resource sets, two SRS resources and two TPMIs indicated by the UL DCI within the application time 2, which is the same as the application time 1. The PUSCH uses one UL TCI state within the application time 2, that is, the UL TCI state 1-2 (e.g., indicated by the DL DCI 2 in FIG. 3), the terminal equipment considers the two UL TCI states associated with the two SRS resource sets to be the same, i.e., the UL TCI state 1-2. From the application time 1 to the application time 2, although the number of UL TCI states has changed from two to one, the terminal equipment does not switch to the sTRP PUSCH transmission within the application time 2, but still performs the mTRP PUSCH transmission. The terminal equipment merely considers the two UL TCI states of the mTRP PUSCH to be the same, i.e., the UL TCI state 1-2.

In some embodiments, in a case where the uplink transmission configuration indication state (UL TCI state) corresponding to the second application time includes one uplink transmission configuration indication state (UL TCI state), the terminal equipment performs the sTRP PUSCH transmission within the second application time, and at least one of information included in the parameter indicated by the third downlink control information: the SRS resource set, the SRS resource, or the TPMI is used to transmit the uplink data within the second application time.

For a method 2, in the application time 2, the PUSCH uses one UL TCI state within the application time 2, i.e., the UL TCI state 1-2 (e.g., indicated by the DL DCI 2 in FIG. 3), and the terminal equipment considers switching to the sTRP PUSCH transmission; the PUSCH uses one default (predefined) SRS resource set (such as the first SRS resource set), that is, the SRS resource set 1; since one SRS field of the UL DCI indicates an SRS resource in the SRS resource set 1, that is, an SRS resource 1, the PUSCH uses the SRS resource 1 indicated by the UL DCI; since one TPMI field of the UL DCI indicates a TPMI associated with the SRS resource 1, that is, a TPMI 1, the PUSCH uses the TPMI 1 indicated by the UL DCI. Similarly, the default (predefined) SRS resource set may also be the SRS resource set 2. Accordingly, the PUSCH uses the SRS resource 2 and a TPMI 2, not illustrated in the figure for simplicity. From the application time 1 to the application time 2, the number of the UL TCI states changes from two to one, thus the terminal equipment switches to the sTRP PUSCH transmission within the application time 2. The used SRS resource set is one default (predefined) SRS resource set (the SRS resource set 1 or the SRS resource set 2), the SRS resource and the TPMI used are the SRS resource and the TPMI associated with the SRS resource set indicated by the UL DCI.

In some embodiments, in a case where the uplink transmission configuration indication state (UL TCI state) corresponding to the second application time includes one uplink transmission configuration indication state (UL TCI state), the terminal equipment performs the sTRP PUSCH transmission within the second application time, and uses at least one of the predefined information: the SRS resource set, the SRS resource, or the TPMI to transmit the uplink data within the second application time.

For a method 3, the PUSCH is determined to use the UL TCI state 1-2 and the SRS resource set 1 according to a method identical to the method 2. The terminal equipment considers switching to the sTRP PUSCH transmission. The PUSCH uses one default (predefined) SRS resource (such as the first SRS resource) in the SRS resource set 1. The PUSCH uses one default (predefined) TPMI. For example, the default (predefined) TPMI may be obtained by the following manner: using an SRS port number of the SRS resource as an antenna port number, and the TPMI available for the SRS resource may be obtained based on the antenna port number. The TPMI includes the precoding matrix determined based on the TPMI index and the layer number, the PUSCH uses the first TPMI among the available TPMIs. Taking Table 7.3.1.1.2-2 of standard TS 38.214 V17.1.0 as an example. This table gives all available TPMIs for 4 antenna ports in some configurations, in which each row corresponds to one available TPML. “The PUSCH uses the first TPMI among the available TPMIs” is equivalent to “the PUSCH uses the TPMI corresponding to a first row”, that is, “1 layer: TPMI=0”.

TABLE 7.3.1.1.2-2
Precoding information and number of layers, for 4 antenna ports, if transform
precoder is disabled, maxRank = 2 or 3 or 4, and ul-FullPowerTransmission
is not configured or configured to fullpowerMode2 or configured to fullpower

| Bit | | Bit | | Bit | |
|---|---|---|---|---|---|
| field | | field | | field | |
| mapped | | mapped | | mapped | |
| to | codebookSubset = | to | codebookSubset = | to | codebookSubset = |
| index | fullyAndPartialAndNonCoherent | index | partialAndNonCoherent | index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 2 layers: TPMI = 0 | 4 | 2 layers: TPMI = 0 | 4 | 2 layers: TPMI = 0 |
| . . . | . . . | . . . | . . . | . . . | . . . |
| 9 | 2 layers: TPMI = 5 | 9 | 2 layers: TPMI = 5 | 9 | 2 layers: TPMI = 5 |
| 10 | 3 layers: TPMI = 0 | 10 | 3 layers: TPMI = 0 | 10 | 3 layers: TPMI = 0 |
| 11 | 4 layers: TPMI = 0 | 11 | 4 layers: TPMI = 0 | 11 | 4 layers: TPMI = 0 |
| 12 | 1 layer: TPMI = 4 | 12 | 1 layer: TPMI = 4 | 12-15 | reserved |
| . . . | . . . | . . . | . . . | | |
| 19 | 1 layer: TPMI = 11 | 19 | 1 layer: TPMI = 11 | | |
| 20 | 2 layers: TPMI = 6 | 20 | 2 layers: TPMI = 6 | | |
| . . . | . . . | . . . | . . . | | |
| 27 | 2 layers: TPMI = 13 | 27 | 2 layers: TPMI = 13 | | |
| 28 | 3 layers: TPMI = 1 | 28 | 3 layers: TPMI = 1 | | |
| 29 | 3 layers: TPMI = 2 | 29 | 3 layers: TPMI = 2 | | |
| 30 | 4 layers: TPMI = 1 | 30 | 4 layers: TPMI = 1 | | |
| 31 | 4 layers: TPMI = 2 | 31 | 4 layers: TPMI = 2 | | |
| 32 | 1 layers: TPMI = 12 | | | | |
| . . . | . . . | | | | |
| 47 | 1 layers: TPMI = 27 | | | | |
| 48 | 2 layers: TPMI = 14 | | | | |
| . . . | . . . | | | | |
| 55 | 2 layers: TPMI = 21 | | | | |
| 56 | 3 layers: TPMI = 3 | | | | |
| . . . | . . . | | | | |
| 59 | 3 layers: TPMI = 6 | | | | |
| 60 | 4 layers: TPMI = 3 | | | | |
| 61 | 4 layers: TPMI = 4 | | | | |
| 62-63 | reserved | | | | |

For a method 4, the PUSCH is determined to use the UL TCI state 1-2 and the SRS resource set 1 according to a method identical to the method 2. The terminal equipment considers switching to the sTRP PUSCH transmission. The PUSCH uses one default (predefined) SRS resource in the SRS resource set 1. The PUSCH uses one default (predefined) TPML. The default (predefined) SRS resource may be obtained in a method below. A plurality of SRS resources included in the SRS resource set 1 may have different numbers of SRS ports. The default (predefined) SRS resource is an SRS resource with a smallest number of SRS ports in the SRS resource set 1. If a plurality of SRS resources with a smallest number of SRS ports are available, a first SRS resource is selected therefrom. The SRS resource is mainly determined here based on considerations of robustness. Enabling the terminal equipment to use a simplest possible PUSCH transmission method within the application time 2 helps to ensure robustness of transmissions. The default (predefined) TPMI may be obtained according to a method identical to the method 3. Usually, the first TPMI corresponds to a smallest number of layers, such as 1 layer in the Table, which also helps to ensure robustness of transmissions.

In some embodiments, in a case where the uplink transmission configuration indication state (UL TCI state) corresponding to the second application time includes one uplink transmission configuration indication state (UL TCI state), the terminal equipment performs the sTRP PUSCH transmission within the second application time, and uses at least one of information associated with the one uplink transmission configuration indication state (UL TCI state): the SRS resource set, the SRS resource, or the TPMI to transmit the uplink data within the second application time.

For a method 5 or a method 6, in the application time 2, the PUSCH uses one UL TCI state within the application time 2, i.e., the UL TCI state 1-2. The terminal equipment considers switching to the sTRP PUSCH transmission; the terminal equipment determines one SRS resource set associated with the UL TCI state 1-2. For example, a source reference signal contained in the UL TCI state 1-2 is one SRS resource that belongs to the SRS resource set 2, then the SRS resource set associated with the UL TCI state 1-2 is the SRS resource set 2. The terminal equipment transmits the PUSCH using the SRS resource set 2. Any of the aforementioned methods can be adopted for the determination of the SRS resource and the TPMI: for example, the method 5, the PUSCH uses one default (predefined) SRS resource (such as the first SRS resource) in the SRS resource set 2, and the PUSCH uses one default (predefined) TPMI (such as the first TPMI); for another example, the method 6, since the UL DCI indicates the SRS resource and the TPMI associated with the SRS resource set 2, the PUSCH uses the SRS resource 2 and the TPMI 2 associated with the SRS resource set 2 indicated by the UL DCI.

Case 2: one UL TCI state is available within the application time 1, the UL DCI indicates one SRS resource set, and two UL TCI states are available within the application time 2.

FIG. 9 is an example diagram illustrating a method of determining uplink data related parameters in Case 2 of an embodiment of this disclosure. Taking a case where the UL DCI indicates the SRS resource set 2, the SRS resource 2 and the TPMI 2 as an example, FIG. 9 schematically illustrates the method of determining the UL TCI state, the SRS resource set, the SRS resource and the TPMI for the PUSCH within the application time 2 for the Case 2.

In some embodiments, in a case where two UL TCI states are available within the second application time, the terminal equipment performs the sTRP PUSCH transmission according to the parameter indicated by the third downlink control information within the second application time, and transmits the uplink data within the second application time using an uplink transmission configuration indication state (UL TCI state) associated with the parameter indicated by the third downlink control information in at least one uplink transmission configuration indication state (UL TCI state) corresponding to the second application time.

For a method 1, the PUSCH uses one SRS resource set, one SRS resource and one TPMI indicated by the UL DCI within the application time 2, which is the same as the application time 1. Taking the SRS resource set 2, the SRS resource 2, and the TPMI 2 as examples in the figure. The PUSCH uses one of the two UL TCI states within the application time 2. This UL TCI state is the UL TCI state associated with the SRS resource set 2 indicated by the UL DCI, that is, the UL TCI state 2-2. The terminal equipment considers performing the sTRP PUSCH transmission. From the application time 1 to the application time 2, although the number of UL TCI states changes from one to two, the terminal equipment does not switch to the mTRP PUSCH transmission within the application time 2, but still performs the sTRP PUSCH transmission. Similarly, the UL DCI may also indicate the SRS resource set 1, the SRS resource 1 and the TPMI 1. Accordingly, the PUSCH uses the UL TCI state 1-2, not illustrated in the figure for simplicity.

In some embodiments, in a case where the uplink transmission configuration indication state (UL TCI state) corresponding to the second application time includes two uplink transmission configuration indication states (UL TCI state), the terminal equipment performs the mTRP PUSCH transmission within the second application time, and uses at least one of information included in the parameter indicated by the third downlink control information and predefined: the SRS resource set, the SRS resource, or the TPMI to transmit the uplink data within the second application time.

For a method 2, in the application time 2, the PUSCH uses two UL TCI states within the application time 2, i.e., the UL TCI state 1-2 and the UL TCI state 2-2. The terminal equipment considers switching to the mTRP PUSCH transmission. Since each UL TCI state needs to be associated with one SRS resource set, the terminal equipment uses two SRS resource sets. The PUSCH uses the two SRS resource sets, i.e., the SRS resource set 1 and the SRS resource set 2. For the SRS resource associated with the SRS resource set 2, since one SRS field of the UL DCI indicates the SRS resource in the SRS resource set 2, i.e., the SRS resource 2, the PUSCH uses the SRS resource 2 indicated by the UL DCI. For the SRS resource associated with the SRS resource set 1, the UL DCI does not indicate the SRS resource, the PUSCH uses one default (predefined) SRS resource (such as the first SRS resource) in the SRS resource set 1. For the TPMI associated with the SRS resource set 2, since one TPMI field of the UL DCI indicates the TPMI associated with the SRS resource 2, that is, the TPMI 2, the PUSCH uses the TPMI 2 indicated by the UL DCI. For the TPMI associated with the SRS resource set 1, the UL DCI does not indicate the TPMI, the PUSCH uses one default (predefined) TPMI. For example, this default (predefined) TPMI may be obtained in a method below. The SRS resource associated with the SRS resource set 1 has been obtained, thus the default (predefined) TPMI is the first TPMI among the TPMIs available for the SRS resource. From the application time 1 to the application time 2, the number of the UL TCI states changes from one to two, thus the terminal equipment switches to the mTRP PUSCH transmission within the application time 2. The SRS resource and the TPMI indicated by the UL DCI are used for the SRS resource set indicated by the UL DCI. The default (predefined) SRS resource and TPMI are used for the SRS resource set not indicated by the UL DCI.

For a method 3, a difference from the method 2 is how to determine one default (predefined) SRS resource and one default (predefined) TPMI for the SRS resource set 1. In the method 3, the default (predefined) SRS resource is the first SRS resource with the smallest number of SRS ports (denoted as an SRS resource F) in the SRS resource set 1, and the default (predefined) TPMI is the first TPMI among the TPMIs available for the SRS resource F.

In some embodiments, in a case where the uplink transmission configuration indication state (UL TCI state) corresponding to the second application time includes two uplink transmission configuration indication states (UL TCI state), the terminal equipment performs the mTRP PUSCH transmission within the second application time, and uses at least one of the predefined information: the SRS resource set, the SRS resource, or the TPMI to transmit the uplink data within the second application time.

For a method 4, in the application time 2, the PUSCH uses two UL TCI states within the application time 2, i.e., the UL TCI state 1-2 and the UL TCI state 2-2. The terminal equipment considers switching to the mTRP PUSCH transmission. The PUSCH uses two SRS resource sets, i.e., the SRS resource set 1 and the SRS resource set 2. The terminal equipment determines two default (predefined) SRS resources and two default (predefined) TPMIs for the two SRS resource sets. For example, for each SRS resource set, the PUSCH uses the first SRS resource in the SRS resource set; and for each SRS resource, the PUSCH uses the first TPMI among the TPMIs available for the SRS resource.

For a method 5, a difference from the method 4 is how to determine two default (predefined) SRS resources and two default (predefined) TPMIs for two SRS resource sets. In the method 5, for each SRS resource set, the PUSCH uses the first SRS resource with a smallest number of SRS ports in the SRS resource set; for each SRS resource, the PUSCH uses the first TPMI among the TPMIs available for the SRS resource.

In some embodiments, in a case where the uplink transmission configuration indication state (UL TCI state) corresponding to the second application time includes two uplink transmission configuration indication states (UL TCI state), the terminal equipment performs the mTRP PUSCH transmission within the second application time, and uses at least one of information associated with the two uplink transmission configuration indication states (UL TCI state): the SRS resource set, the SRS resource, or the TPMI to transmit the uplink data within the second application time.

For a method 6, in the application time 2, the PUSCH uses two UL TCI states within the application time 2, and the terminal equipment considers switching to the mTRP PUSCH transmission. The SRS resource sets associated with the two UL TCI states are the SRS resource set 1 and the SRS resource set 2, thus the terminal equipment uses these two SRS resource sets. The terminal equipment determines the SRS resource and the TPMI for each SRS resource set, and may adopt any of the aforementioned methods, thus the method 6 may be equivalent to the method 4 or the method 5. For example, FIG. 9 illustrates that the method 6 adopts the method of determining the SRS resource and the TPMI for each SRS resource set in the method 5. Alternatively, the method 6 may also adopt the method of determining the SRS resource and the TPMI for each SRS resource set in the method 4, which is not enumerated here one by one.

Case 3: 2 UL TCI states are available within the application time 1, the UL DCI indicates 2 SRS resource sets, and 2 UL TCI states are available within the application time 2.

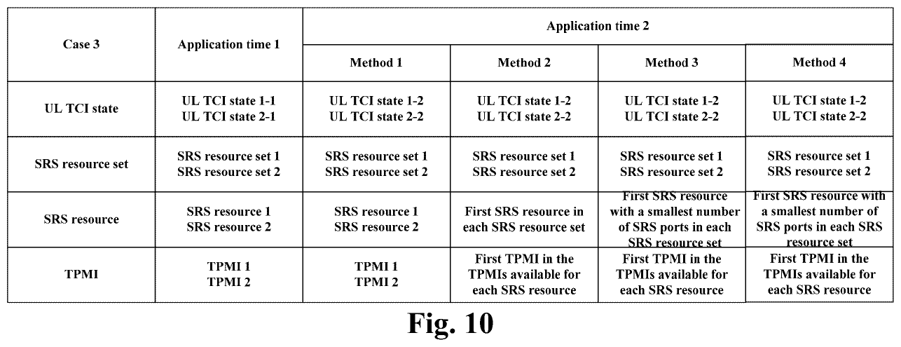

FIG. 10 is an example diagram illustrating a method of determining uplink data related parameters in Case 3 of an embodiment of this disclosure. FIG. 10 schematically illustrates the method of determining the UL TCI state, the SRS resource set, the SRS resource and the TPMI for the PUSCH within the application time 2 for the Case 3.

In some embodiments, in a case where two UL TCI states are available within the second application time, the terminal equipment performs the mTRP PUSCH transmission according to the parameter indicated by the third downlink control information within the second application time, and uses the uplink transmission configuration indication state (UL TCI state) associated with the parameter indicated by the third downlink control information in at least one uplink transmission configuration indication state (UL TCI state) corresponding to the second application time to transmit the uplink data within the second application time.

For a method 1, the PUSCH uses two SRS resource sets, two SRS resources and two TPMI indicated by the UL DCI within the application time 2, which is the same as the application time 1. The terminal equipment considers performing the mTRP PUSCH transmission. The PUSCH uses the two UL TCI states associated with the two SRS resource sets within the application time 2, i.e., the UL TCI state 1-2 and the UL TCI state 2-2 associated with the SRS resource set 1 and the SRS resource set 2, respectively.

In some embodiments, in a case where the uplink transmission configuration indication state (UL TCI state) corresponding to the second application time includes two uplink transmission configuration indication states (UL TCI state), the terminal equipment performs the mTRP PUSCH transmission within the second application time, and uses at least one of the predefined information: the SRS resource set, the SRS resource, or the TPMI to transmit the uplink data within the second application time.

For a method 2, the PUSCH uses two UL TCI states within the application time 2. Each UL TCI state needs to be associated with one SRS resource set, thus the terminal equipment uses two SRS resource sets. The terminal equipment determines two default (predefined) SRS resources and two default (predefined) TPMIs for the two SRS resource sets. For example, for each SRS resource set, the PUSCH uses the first SRS resource in the SRS resource set; for each SRS resource, the PUSCH uses the first TPMI among the TPMIs available for the SRS resource.

For a method 3, a difference from the method 2 is how to determine two default (predefined) SRS resources and two default (predefined) TPMIs for two SRS resource sets. In the method 3, for each SRS resource set, the PUSCH uses the first SRS resource with the smallest number of SRS ports in the SRS resource set; for each SRS resource, the PUSCH uses the first TPMI among the TPMIs available for the SRS resource.

In some embodiments, in a case where the uplink transmission configuration indication state (UL TCI state) corresponding to the second application time includes two uplink transmission configuration indication states (UL TCI state), the terminal equipment performs the mTRP PUSCH transmission within the second application time, and uses at least one of information associated with the two uplink transmission configuration indication states (UL TCI state): the SRS resource set, the SRS resource, or the TPMI to transmit the uplink data within the second application time.

For a method 4, in the application time 2, the PUSCH uses two UL TCI states within the application time 2, and the terminal equipment considers switching to the mTRP PUSCH transmission. The SRS resource set associated with the two UL TCI states is the SRS resource set 1 and the SRS resource set 2, thus the terminal equipment uses these two SRS resource sets. The terminal equipment determines the SRS resource and the TPMI for each SRS resource set, and may adopt any of the aforementioned methods, thus the method 4 may be equivalent to the method 2 or the method 3. For example, FIG. 10 illustrates that the method 4 adopts the method of determining the SRS resource and the TPMI for each SRS resource set in the method 3. Alternatively, the method 4 may also adopt the method of determining the SRS resource and the TPMI for each SRS resource set in the method 2, which is not enumerated here one by one.

Case 4: 1 UL TCI state is available within the application time 1, the UL DCI indicates 1 SRS resource set, and 1 UL TCI state is available within the application time 2.

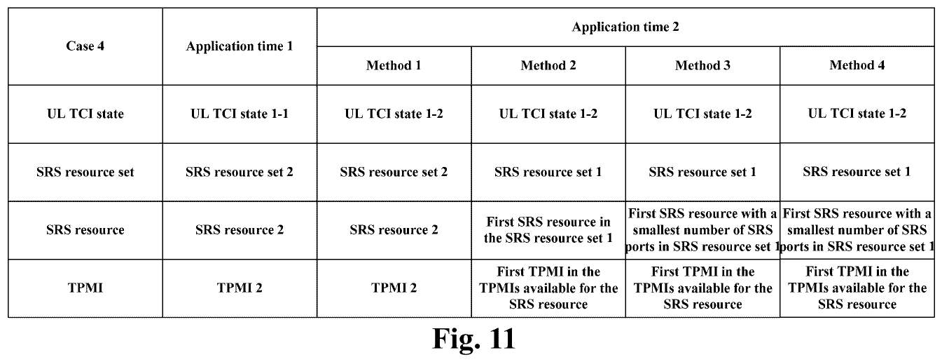

FIG. 11 is an example diagram illustrating a method of determining uplink data related parameters in Case 4 of an embodiment of this disclosure. Taking the UL DCI to indicate the SRS resource set 2, the SRS resource 2 and the TPMI 2 as an example, FIG. 11 schematically illustrates the method of determining the UL TCI state, the SRS resource set, the SRS resource and the TPMI for the PUSCH within the application time 2 for the Case 4.

In some embodiments, in a case where one UL TCI state is available within the second application time, the terminal equipment performs the sTRP PUSCH transmission according to the parameter indicated by the third downlink control information within the second application time, and uses the one uplink transmission configuration indication state (UL TCI state) to transmit the uplink data within the second application time. For the method 1, the PUSCH uses one SRS resource set, one SRS resource and one TPMI indicated by the UL DCI within the application time 2, which is the same as the application time 1. The terminal equipment considers performing the sTRP PUSCH transmission. Only one UL TCI state, i.e., the UL TCI state 1-2, is available within the application time 2, thus the terminal equipment uses this UL TCI state to transmit the PUSCH.

In some embodiments, in a case where the uplink transmission configuration indication state (UL TCI state) corresponding to the second application time includes one uplink transmission configuration indication state (UL TCI state), the terminal equipment performs the sTRP PUSCH transmission within the second application time, and uses at least one of the predefined information: the SRS resource set, the SRS resource, or the TPMI to transmit the uplink data within the second application time.

For a method 2, the PUSCH uses one UL TCI state within the application time 2 for the sTRP PUSCH transmission. The terminal equipment determines one default (predefined) SRS resource set, one default (predefined) SRS resource and one default (predefined) TPMI. For example, the PUSCH uses the first SRS resource set, i.e., the SRS resource set 1, uses the first SRS resource in the SRS resource set 1 (denoted as an SRS resource F), and uses the first TPMI among the TPMIs available for the SRS resource F.

For a method 3, a difference from the method 2 is how to determine one default (predefined) SRS resource and one default (predefined) TPMI. In the method 3, the PUSCH uses the first SRS resource with the smallest number of SRS ports in the SRS resource set 1, and uses the first TPMI among the TPMIs available for this SRS resource.

In some embodiments, in a case where the uplink transmission configuration indication state (UL TCI state) corresponding to the second application time includes one uplink transmission configuration indication state (UL TCI state), the terminal equipment performs the sTRP PUSCH transmission within the second application time, and uses at least one of information associated with the one uplink transmission configuration indication state (UL TCI state): the SRS resource set, the SRS resource, or the TPMI to transmit the uplink data within the second application time.

For a method 4, in the application time 2, the PUSCH uses one UL TCI state within the application time 2, i.e., the UL TCI state 1-2. The terminal equipment considers switching to the sTRP PUSCH transmission. The terminal equipment determines one SRS resource set associated with the UL TCI state 1-2. For example, the source reference signal contained in the UL TCI state 1-2 is one SRS resource that belongs to the SRS resource set 1, then the SRS resource set associated with the UL TCI state 1-2 is the SRS resource set 1. The terminal equipment uses the SRS resource set 1 to transmit the PUSCH. Any of the aforementioned methods can be adopted for the determination of the SRS resource and the TPMI, thus the method 4 may be equivalent to the method 2 or the method 3. For example, FIG. 11 illustrates that the method 4 adopts the method of determining the SRS resource and the TPMI in the method 3. Alternatively, the method 4 may also adopt the method of determining the SRS resource and the TPMI in the method 2, which is not enumerated here one by one.

The description is given above by taking a codebook based PUSCH transmission as an example. A description is given below by taking a non-codebook based PUSCH transmission as an example.

For the non-codebook based PUSCH, the TPMI does not need to be indicated, thus no TPMI field is existed in the UL DCI. An SRS port number of all SRS resources in one SRS resource set is 1, thus “the first SRS resource in the resource set” is equivalent to “the first SRS resource with the smallest number of SRS ports in the SRS resource set”.

In some embodiments, for the non-codebook based PUSCH transmission, relevant parameters may still be determined based on the method illustrated in FIGS. 8-11. For example, the row where the TPMI is located in FIGS. 8-11 is deleted, the column where “the first SRS resource with the smallest number of SRS ports” located in FIGS. 8-11 is deleted, the non-codebook based PUSCH transmission method may be obtained, and will not be repeatedly described here.

In some embodiments, part or all of at least one uplink transmission configuration indication state (UL TCI state) corresponding to the first application time is used to transmit the uplink data within the second application time.

In some embodiments, the uplink transmission configuration indication state (UL TCI state) associated with the parameter indicated by the third downlink control information in at least one uplink transmission configuration indication state (UL TCI state) corresponding to the first application time is used.

For example, the terminal equipment determines the UL TCI state within the second application time based on the UL TCI state indicated by the first downlink control information. The terminal equipment determines relevant parameters for the PUSCH transmission within the second application time based on the parameter indicated by the third downlink control information. The terminal equipment determines whether to perform the sTRP PUSCH transmission or the mTRP PUSCH transmission according to the number of UL TCI states indicated by the first downlink control information or the parameter indicated by the third downlink control information, such as the number of SRS resource sets.

For example, although the UL TCI state is updated within the second application time (for example, the DL DCI 2 in FIG. 3 indicates the updated UL TCI state), the terminal equipment does not use the updated UL TCI state and still performs the PUSCH transmission in the same manner as the UL DCI and the PUSCH located in the first application time, that is, a presence of the second application time is ignored.

For example, the DL DCI 1 in FIG. 3 indicates the UL TCI state 1-1, uses the UL TCI state 1-1 to transmit the uplink data within the second application time; and under a premise that the DL DCI 1 indicates the UL TCI state 1-1, the UL DCI indicates the SRS resource set 1 corresponding to the UL TCI state 1-1, and then the terminal equipment performs the sTRP PUSCH transmission, and performs the sTRP PUSCH transmission according to at least one of the SRS resource set 1, the SRS resource 1, or the TPMI 1 indicated by the UL DCI; in a case where the DL DCI 1 indicates two UL TCI states, the uplink data transmission method is similar to the aforementioned methods, and is not enumerated here one by one.

How to transmit the PUSCH is described below after the relevant parameters for the PUSCH transmission are determined.

In some embodiments, for at least one uplink repetition (PUSCH repetition) spanning the first application time and the second application time, the uplink data within the second application time starts from the first uplink repetition (PUSCH repetition) after a moment in which the second application time starts. The uplink repetition (PUSCH repetition) includes at least one of a nominal repetition, an actual repetition, a symbol, or a slot.

In some embodiments, for the PUSCH repetition spanning at least two application times, starting from a first nominal repetition after the moment in which the second application time starts, the PUSCH uses the UL TCI state, the SRS resource set, the SRS resource and the TPMI within the application time.

In some embodiments, starting from the first uplink repetition (PUSCH repetition) after the moment in which the second application time starts, at least one uplink transmission configuration indication state (UL TCI state) and/or SRS resource set for the uplink data transmission is associated or mapped to K uplink repetitions (PUSCH repetitions), where the moment in which the K uplink repetitions (PUSCH repetitions) start is within the second application time. For example, the use of the UL TCI state, the SRS resource set, the SRS resource and the TPMI continues within a current application time and stops at the first nominal repetition after a moment in which a next application time starts. Starting from this nominal repetition, the PUSCH uses the UL TCI state, the SRS resource set, the SRS resource and the TPMI within the next application time, and so on.

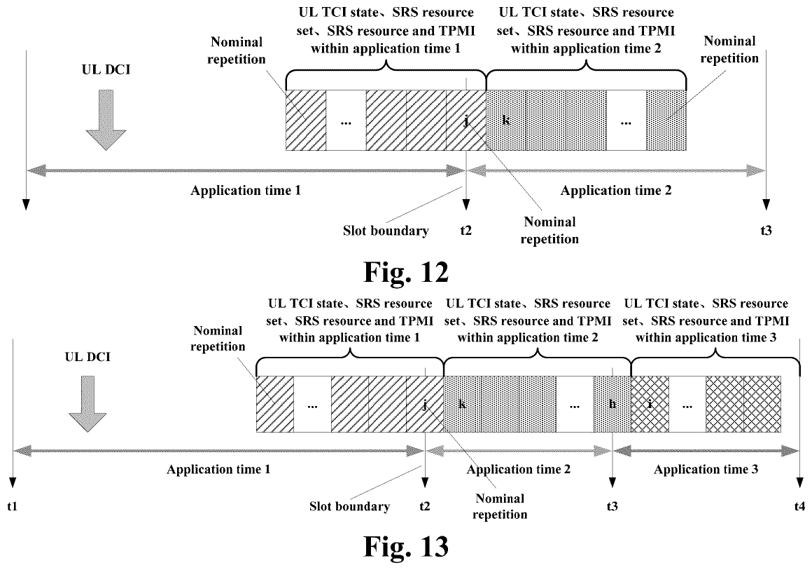

FIG. 12 is a schematic diagram illustrating a PUSCH transmission according to an embodiment of this disclosure. For example, for the PUSCH repetition type B, the PUSCH repetition spans the application time 1 and the application time 2. A moment in which the application time 2 starts is t2, in which one nominal repetition (nominal repetition j) spans the t2, that is, spans a slot boundary. Starting from the first nominal repetition (nominal repetition k) after the t2, the PUSCH repetition uses the UL TCI state, the SRS resource set, the SRS resource and the TPMI within the application time 2. For the PUSCH repetition before the nominal repetition k, the UL TCI state, the SRS resource set, the SRS resource and the TPMI within the application time 1 are used.

FIG. 13 is another schematic diagram illustrating a PUSCH transmission according to an embodiment of this disclosure. FIG. 13 schematically illustrates a situation where the PUSCH spans three application times, and similarities to FIG. 12 will not be described again. For the PUSCH repetition type B, the nominal repetition k is the first nominal repetition after the moment t2 in which the application time 2 starts, and a nominal repetition i is the first nominal repetition after the moment t3 in which the application time 3 starts. Therefore, from the nominal repetition k to a nominal repetition h, the UL TCI state, the SRS resource set, the SRS resource and the TPMI within the application time 2 are used. From the nominal repetition i to a last nominal repetition in the figure, the UL TCI state, the SRS resource set, the SRS resource and the TPMI within the application time 3 are used.

In some embodiments, in a case where two uplink transmission configuration indication states (UL TCI state) and/or SRS resource sets are used for the uplink data transmission, the at least two uplink transmission configuration indication states (UL TCI state) and/or SRS resource sets are mapped to the K uplink repetitions (PUSCH repetitions) in a predefined order.

In some embodiments, the predefined order is the first uplink transmission configuration indication state (UL TCI state) and/or SRS resource set, followed by the second uplink transmission configuration indication state (UL TCI state) and/or SRS resource set, or the second uplink transmission configuration indication state (UL TCI state) and/or SRS resource set, followed by the first uplink transmission configuration indication state (UL TCI state) and/or SRS resource set.

In some embodiments, for the PUSCH repetition spanning at least two application times, starting from the first nominal repetition after the moment in which the second application time starts, the UL TCI state and/or the SRS resource set within the application time is associated or mapped to K nominal repetitions, where the moments in which the K nominal repetitions start are within the application time, also known as K nominal repetitions within the application time.

For example, within some application times, an association of the UL TCI state and/or the SRS resource sets with the nominal repetition is determined independently within each application time, that is, association or mapping is anew performed within each application time.

For example, from the application time 1 to the application time 2, if the number of the UL TCI states changes from 1 to 2, or from 2 to 1, the association previously determined is obviously no longer applicable, and the association or mapping needs to be anew performed within the application time 2.

For example, as illustrated in FIG. 12, the K nominal repetitions include nominal repetitions starting from the nominal repetition k within the application time 2.

For example, as illustrated in FIG. 13, the K nominal repetitions include the nominal repetition k to the nominal repetition h within the application time 2.

In some embodiments, when two UL TCI states and/or two SRS resource sets are available within the second application time, the two UL TCI states and/or the two SRS resource sets are mapped to the K nominal repetitions in a predefined order, in which the predefined order is “the first SRS resource set and/or UL TCI state, followed by the second SRS resource set and/or UL TCI state”, or “the second SRS resource set and/or UL TCI state, followed by the first SRS resource set and/or UL TCI state”.

For example, from the application time 1 to the application time 2, the terminal equipment changes from the sTRP PUSCH transmission to the mTRP PUSCH transmission. The UL DCI determined according to the application time 1 does not indicate a mapping order of the mTRP PUSCH, thus the terminal equipment maps two UL TCI states and/or two SRS resource sets to the K nominal repetitions according to the predefined order.

For example, as illustrated in FIG. 12, the K nominal repetitions include nominal repetitions starting from the nominal repetition k within the application time 2. When K>2 and cyclicMapping is enabled, the first and second UL TCI states and/or SRS resource sets are applied to the first and second nominal repetitions in K consecutive nominal repetitions, respectively, and a same mapping method is applied to remaining nominal repetitions in the K consecutive nominal repetitions; and when K>2 and sequentialMapping is enabled, the first UL TCI state and/or SRS resource set is applied to the first and second nominal repetitions of the K consecutive nominal repetitions, and the second UL TCI state and/or SRS resource set is applied to third and fourth nominal repetitions in the K consecutive nominal repetitions, and a same mapping method is applied to the remaining nominal repetitions in the K consecutive nominal repetitions.

For example, the number of the UL TCI states within the application time 1 is 2. According to instructions of the UL DCI, the terminal equipment maps the first (denoted as #1) and the second (denoted as #2) UL TCI state and the SRS resource set to K=8 nominal repetitions in an order of #2, #1, #2, #1, #2, #1, #2, #1, at a subsequent moment, the DL DCI indicates 2 different UL TCI states within the application time 2, such that last 4 nominal repetitions are located at the application time 2, then the terminal equipment is mapped to the last 4 nominal repetitions in an order of #1, #2, #1, #2 (predefined order), which is wholly equivalent to being mapped to 8 nominal repetitions in an order of #2, #1, #2, #1, #1, #2, #1, and #2.

In some embodiments, in a case where one uplink transmission configuration indication state (UL TCI state) and/or SRS resource set is used for the uplink data transmission, the one uplink transmission configuration indication state (UL TCI state) and/or SRS resource set is mapped to the K uplink repetitions (PUSCH repetitions).

In some embodiments, when one UL TCI state and/or one SRS resource set is available within the second application time, the UL TCI state and/or SRS resource set is mapped to the K nominal repetitions.

For example, from the application time 1 to the application time 2, if one UL TCI state associated with the SRS resource set 2 changes to one different UL TCI state, or if 2 UL TCI states associated with the SRS resource set 1 and the SRS resource set 2 respectively change to one UL TCI state, then the terminal equipment maps one UL TCI state within the application time 2 to the K nominal repetitions, and maps the SRS resource set associated with the one UL TCI state to the K nominal repetitions.

In some embodiments, the K uplink repetitions (PUSCH repetitions) use a mapping method between the SRS resource set and the uplink repetition (PUSCH repetition) determined according to the third downlink control information.

In some embodiments, for the PUSCH repetition that spans at least two application times, the method of mapping the SRS resource set to the nominal repetition determined within the first application time before that continues to be used within the second application time, however, the UL TCI state within the second application time is mapped to the nominal repetition within the second application time.

For example, the number of the UL TCI states within the application time 1 is 2. According to instructions of the UL DCI, the terminal equipment maps the first (denoted as #1) and the second (denoted as #2) UL TCI states and the SRS resource sets to K=8 nominal repetitions in an order of #2, #1, #2, #1, #2, #1, #2, #1, in a subsequent moment, the DL DCI indicates 2 different UL TCI states within the application time 2, such that the last 4 nominal repetitions are located at the application time 2, then the terminal equipment still maps the two SRS resource sets to the last 4 nominal repetitions in an order of #2, #1, #2, #1, but replaces the two UL TCI states applied to the last 4 nominal repetitions with the two UL TCI states within the application time 2, which is wholly equivalent to mapping the two SRS resource sets to K=8 nominal repetitions in an order of #2, #1, #2, #1, #2, #1, #2, #1, mapping the two UL TCI states within the application time 1 to the first four nominal repetitions in an order of #2, #1, #2, #1, and mapping the two UL TCI states within the application time 2 to the last four nominal repetitions in an order of #2, #1, #2, and #1.

In some embodiments, the aforementioned nominal repetitions may be replaced with a symbol, or a slot, or an actual repetition, and other similarities will not be described again.

For example, for the PUSCH spanning at least two application times, starting from a first symbol or slot or actual repetition after a moment in which the second application time starts, the PUSCH uses the UL TCI state and the SRS resource set within the application time.

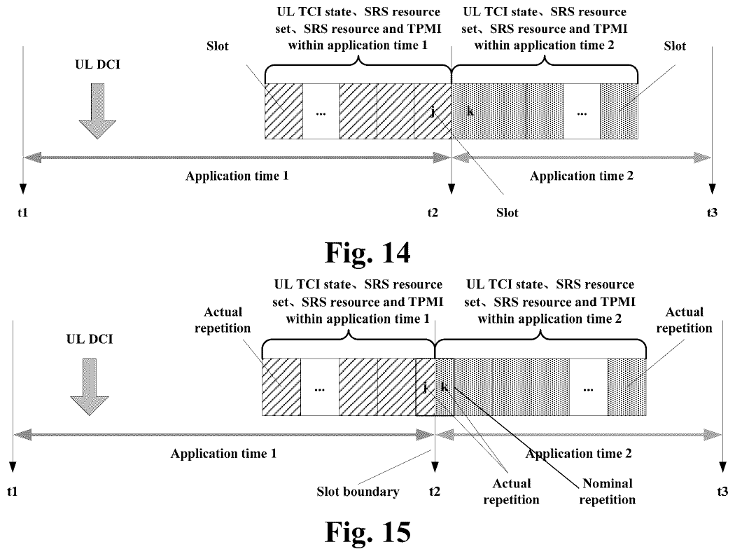

FIGS. 14 and 15 schematically illustrate this. FIG. 14 is another schematic diagram illustrating a PUSCH transmission according to an embodiment of this disclosure. FIG. 15 is another schematic diagram illustrating a PUSCH transmission according to an embodiment of this disclosure.

As illustrated in FIGS. 14 and 15, starting from the first symbol after the moment t2 in which the application time 2 starts, and the PUSCH uses the UL TCI state and the SRS resource set within the application time 2. FIG. 14 takes the PUSCH repetition type A as an example. In this case, “starting from the first symbol after the t2” is equivalent to “starting from the first slot after the t2”. FIG. 15 takes the PUSCH repetition type B as an example. One nominal repetition spans the slot boundary t2, thus is divided into two actual repetitions (j, k). In this case, “starting from the first symbol after the t2” is equivalent to “starting from the first actual repetition after the t2”.

For example, when two UL TCI states and/or two SRS resource sets are available within the second application time, the two UL TCI states and/or the two SRS resource sets are mapped to the K′ actual repetitions within the second application time in a predefined order.

FIG. 15 schematically illustrates this. Starting from the first actual repetition after the t2, the two UL TCI states and/or the two SRS resource sets are mapped to the K′ actual repetitions within the application time 2. The mapping method is the same as that mentioned above, except that the “nominal repetition” is replaced with the “actual repetition”.

The above implementations only illustrate the embodiments of this disclosure. However, this disclosure is not limited thereto, and appropriate variants may be made on the basis of these implementations. For example, the above implementations may be executed separately, or one or more of them may be combined together.

As can be seen from the embodiments, the terminal equipment determines relevant parameters for the uplink data transmission within the second application time based on the parameter indicated by the third downlink control information and/or at least one uplink transmission configuration indication state (UL TCI state) corresponding to the second application time. Therefore, ambiguity can be avoided in the use of relevant parameters for uplink data transmission, so as to avoid a resulting failure in uplink data transmission.

### Embodiments of a Second Aspect

The embodiments of this disclosure provide an uplink data transmitting method, applied to a terminal equipment side. The embodiments of this disclosure can be combined with the embodiments of the first aspect, or can be implemented independently. A same content as the embodiment of the first aspect will not be described again.

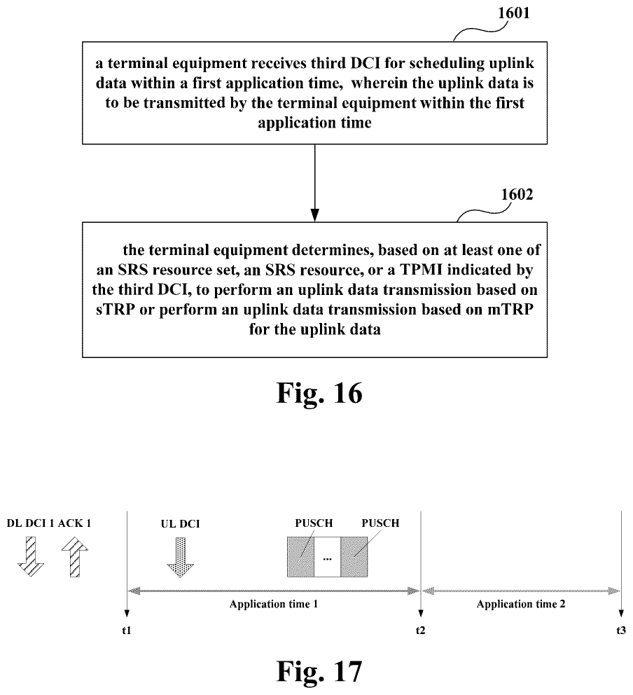

FIG. 16 is another schematic diagram illustrating the uplink data transmitting method according to an embodiment of this disclosure. As illustrated in FIG. 16, the method includes:
1601: a terminal equipment receives third downlink control information for scheduling uplink data within a first application time, wherein the uplink data is to be transmitted by the terminal equipment within the first application time; and
1602: the terminal equipment determines, based on at least one of an SRS resource set, an SRS resource, or a TPMI indicated by the third downlink control information, to perform an uplink data transmission based on a single transmission and reception point (sTRP) or perform an uplink data transmission based on multiple transmission and reception points (mTRP) for the uplink data.

Therefore, the terminal equipment transmits the uplink data only within the first application time, and can determine relevant parameters associated with the uplink data, such as at least one of the SRS resource set, the SRS resource, or the TPMI. Therefore, ambiguity can be avoided in the use of relevant parameters for uplink data transmission, so as to avoid a resulting failure in uplink data transmission.

Refer to the embodiments of the first aspect for specific limitations of the “first application time”, the “third downlink control information”, the “uplink data transmission based on a single transmission and reception point (sTRP)”, “uplink data transmission based on multiple transmission and reception points (mTRP)” and the “SRS resource set, SRS resource, or TPMI”, which will not be repeatedly described here.

FIG. 17 is another schematic diagram illustrating the signaling transmission process according to an embodiment of this disclosure. For example, as illustrated in FIG. 17, restrictions are imposed on PUSCH scheduling based on the UL DCI. For example, the UL DCI and the PUSCH are restricted to be located at a same application time. In other words, the terminal equipment expects the UL DCI and the PUSCH scheduled by the UL DCI to be located at the same application time. In this case, the terminal equipment uses the UL TCI state within the application time (such as the UL TCI state indicated by the DL DCI 1), and determines the SRS resource set, the UL TCI state and the SRS resource based on the SRS resource set indicator field of the UL DCI; and determines whether to perform the sTRP PUSCH based transmission or the mTRP PUSCH based transmission according to the SRS resource set. Thus, relevant parameters associated with the uplink data can be determined.

It is worth noting that the FIGS. 16 and 17 only schematically illustrate the embodiments of this disclosure. Taking a terminal equipment as an example, however, this disclosure is not limited thereto. For example, an order of execution of the operations may be appropriately adjusted, and furthermore, some other operations may be added, or some operations therein may be reduced. In addition, the objects of the operations can also be adjusted. And appropriate variants may be made by those skilled in the art according to the above content, without being limited to what is contained in the FIGS. 16-17.

The above implementations only illustrate the embodiments of this disclosure. However, this disclosure is not limited thereto, and appropriate variants may be made on the basis of these implementations. For example, the above implementations may be executed separately, or one or more of them may be combined together.

As can be seen from the embodiments, the terminal equipment only transmits the uplink data within the first application time and can determine relevant parameters associated with the uplink data, such as at least one of the SRS resource set, the SRS resource, or the TPMI. Therefore, ambiguity can be avoided in the use of relevant parameters for uplink data transmission, so as to avoid a resulting failure in uplink data transmission.

### Embodiments of a Third Aspect

The embodiments of this disclosure provide an uplink data transmitting method, applied to a terminal equipment side. The embodiments of this disclosure can be combined with the embodiments of the first aspect, or can be implemented independently. A same content as the embodiments of the first and second aspects will not be described again.

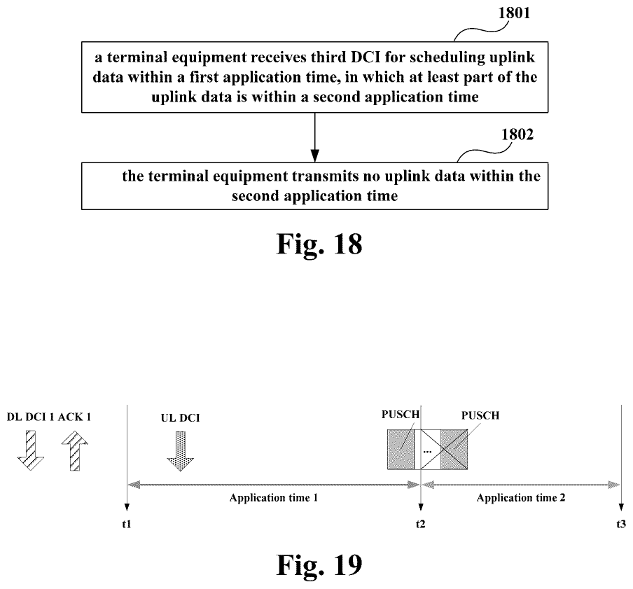

FIG. 18 is another schematic diagram illustrating the uplink data transmitting method according to an embodiment of this disclosure. As illustrated in FIG. 18, the method includes:
1801: a terminal equipment receives third downlink control information for scheduling uplink data within a first application time, in which at least part of the uplink data is within a second application time; and
1802: the terminal equipment transmits no uplink data within the second application time.

Thus, the terminal equipment transmits the uplink data only within the first application time and does not transmit the uplink data within the second application time. Therefore, the relevant parameters associated with the uplink data within the first application time can be determined. Therefore, ambiguity can be avoided in the use of relevant parameters for uplink data transmission, so as to avoid a resulting failure in uplink data transmission.

Refer to the embodiments of the first aspect for specific limitations of the “first application time”, the “third downlink control information”, which will not be repeatedly described here. For example, the relevant parameters of the uplink data within the first application time may be determined with reference to the embodiments of the second aspect.

FIG. 19 is another schematic diagram illustrating the signaling transmission process according to an embodiment of this disclosure. For example, as illustrated in FIG. 19, the application time of the UL TCI state indicated by the DL DCI 1 (the first application time: the application time 1), the terminal equipment uses the UL TCI state within the application time (e.g., the UL TCI state indicated by the DL DCI 1), and determines the SRS resource set, the UL TCI state and the SRS resource based on the SRS resource set indicator field of the UL DCI; and determines whether to perform the sTRP PUSCH based transmission or the mTRP PUSCH based transmission according to the SRS resource set, Thus, the relevant parameters associated with the uplink data can be determined. For the second application time (application time 2), the terminal equipment discards the PUSCH, that is, transmits no PUSCH within the second application time. Therefore, ambiguity can be avoided in the use of relevant parameters for uplink data transmission, so as to avoid a resulting failure in uplink data transmission.

It is worth noting that the FIGS. 18 and 19 only schematically illustrate the embodiments of this disclosure. Taking a terminal equipment as an example, however, this disclosure is not limited thereto. For example, an order of execution of the operations may be appropriately adjusted, and furthermore, some other operations may be added, or some operations therein may be reduced. In addition, the objects of the operations can also be adjusted. And appropriate variants may be made by those skilled in the art according to the above content, without being limited to what is contained in the FIGS. 18-19.

The above implementations only illustrate the embodiments of this disclosure. However, this disclosure is not limited thereto, and appropriate variants may be made on the basis of these implementations. For example, the above implementations may be executed separately, or one or more of them may be combined together.

As can be seen from the embodiments, the terminal equipment transmits the uplink data only within the first application time and does not transmit the uplink data within the second application time. Therefore, the relevant parameters associated with the uplink data within the first application time can be determined. Therefore, ambiguity can be avoided in the use of relevant parameters for uplink data transmission, so as to avoid a resulting failure in uplink data transmission.

### Embodiments of a Fourth Aspect

The embodiments of this disclosure provide an uplink data receiving method, applied to a network device side. The embodiments of this disclosure can be combined with the embodiments of the first aspect, or can be implemented independently. A same content as the embodiments of the first aspect will not be described again.

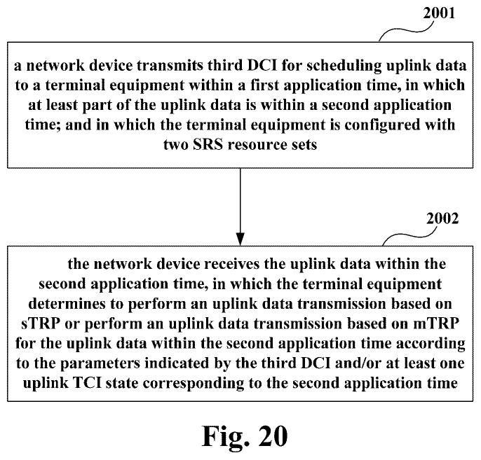

FIG. 20 is a schematic diagram illustrating an uplink data receiving method according to an embodiment of this disclosure. As illustrated in FIG. 20, the method includes:
2001: a network device transmits third downlink control information for scheduling uplink data to a terminal equipment within a first application time, in which at least part of the uplink data is within a second application time; and in which the terminal equipment is configured with two SRS resource sets; and
2002: the network device receives the uplink data within the second application time, in which the terminal equipment determines to perform an uplink data transmission based on a single transmission and reception point (sTRP) or perform an uplink data transmission based on multiple transmission and reception points (mTRP) for the uplink data within the second application time, according to the parameter indicated by the third downlink control information and/or at least one uplink transmission configuration indication state (UL TCI state) corresponding to the second application time.

It is worth noting that the FIG. 20 only schematically illustrates the embodiments of this disclosure, however, this disclosure is not limited thereto. For example, an order of execution of the operations may be appropriately adjusted, and furthermore, some other operations may be added, or some operations therein may be reduced. And appropriate variants may be made by those skilled in the art according to the above content, without being limited to what is contained in the FIG. 20.

The above implementations only illustrate the embodiments of this disclosure. However, this disclosure is not limited thereto, and appropriate variants may be made on the basis of these implementations. For example, the above implementations may be executed separately, or one or more of them may be combined together.

As can be seen from the embodiments, the terminal equipment determines relevant parameters for uplink data transmission within the second application time based on the parameter indicated by the third downlink control information and/or at least one uplink transmission configuration indication state (UL TCI state) corresponding to the second application time. Therefore, ambiguity can be avoided in the use of relevant parameters for uplink data transmission, so as to avoid a resulting failure in uplink data transmission.

### Embodiments of a Fifth Aspect

The embodiments of this disclosure provide an uplink data receiving method, applied to a network device side. The embodiments of this disclosure can be combined with the embodiments of the first aspect, or can be implemented independently. A same content as the embodiments of the second aspect will not be described again.

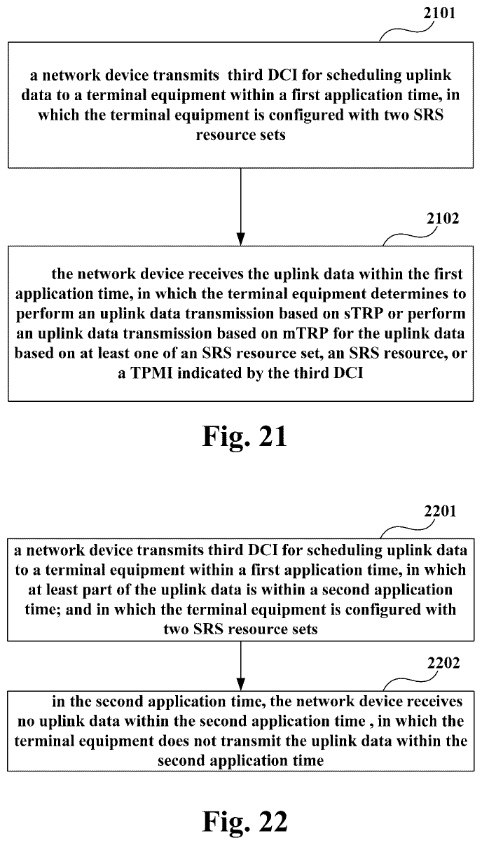

FIG. 21 is another schematic diagram illustrating the uplink data receiving method according to an embodiment of this disclosure. As illustrated in FIG. 21, the method includes:
2101: a network device transmits third downlink control information for scheduling uplink data to a terminal equipment within a first application time, in which the terminal equipment is configured with two SRS resource sets; and
2102: the network device receives the uplink data within the first application time, in which the terminal equipment determines to perform an uplink data transmission based on a single transmission and reception point (sTRP) or perform an uplink data transmission based on multiple transmission and reception points (mTRP) for the uplink data, based on at least one of an SRS resource set, an SRS resource, or a TPMI indicated by the third downlink control information.

It is worth noting that the FIG. 21 only schematically illustrates the embodiments of this disclosure, however, this disclosure is not limited thereto. For example, an order of execution of the operations may be appropriately adjusted, and furthermore, some other operations may be added, or some operations therein may be reduced. And appropriate variants may be made by those skilled in the art according to the above content, without being limited to what is contained in the FIG. 21.

The above implementations only illustrate the embodiments of this disclosure. However, this disclosure is not limited thereto, and appropriate variants may be made on the basis of these implementations. For example, the above implementations may be executed separately, or one or more of them may be combined together.

As can be seen from the embodiments, the terminal equipment transmits the uplink data only within the first application time and can determine relevant parameters associated with the uplink data, such as at least one of the SRS resource set, the SRS resource, or the TPMI. Therefore, ambiguity can be avoided in the use of relevant parameters for uplink data transmission, so as to avoid a resulting failure in uplink data transmission.

### Embodiments of a Sixth Aspect

The embodiments of this disclosure provide an uplink data receiving method, applied to a network device side. The embodiments of this disclosure can be combined with the embodiments of the first aspect, or can be implemented independently. A same content as the embodiments of the third aspect will not be described again.

FIG. 22 is another schematic diagram illustrating the uplink data receiving method according to an embodiment of this disclosure. As illustrated in FIG. 22, the method includes:
2201: a network device transmits third downlink control information for scheduling uplink data to a terminal equipment within a first application time, in which at least part of the uplink data is within a second application time; and in which the terminal equipment is configured with two SRS resource sets;
2202: the network device, in the second application time, receives no uplink data within the second application time, in which the terminal equipment does not transmit the uplink data within the second application time.

It is worth noting that the FIG. 22 only schematically illustrates the embodiments of this disclosure, however, this disclosure is not limited thereto. For example, an order of execution of the operations may be appropriately adjusted, and furthermore, some other operations may be added, or some operations therein may be reduced. And appropriate variants may be made by those skilled in the art according to the above content, without being limited to what is contained in the FIG. 22.

The above implementations only illustrate the embodiments of this disclosure. However, this disclosure is not limited thereto, and appropriate variants may be made on the basis of these implementations. For example, the above implementations may be executed separately, or one or more of them may be combined together.

As can be seen from the embodiments, the terminal equipment transmits the uplink data only within the first application time and does not transmit the uplink data within the second application time. Thus, relevant parameters associated with the uplink data within the first application time can be determined. Therefore, ambiguity can be avoided in the use of relevant parameters for uplink data transmission, so as to avoid a resulting failure in uplink data transmission.

### Embodiments of a Seventh Aspect

The embodiments of this disclosure provide an uplink data transmitting device. The device may be, for example, a terminal equipment, or may be a or some part(s) or component(s) configured in the terminal equipment. The terminal equipment is configured with two SRS resource sets. In addition, a same content as the embodiments of the first aspect will not be described again.

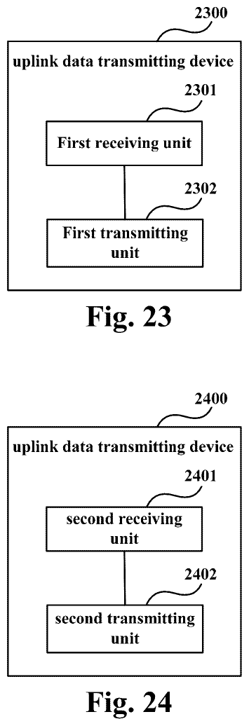

FIG. 23 is a schematic diagram illustrating an uplink data transmitting device according to an embodiment of this disclosure. As illustrated in FIG. 23, an uplink data transmitting device 2300 includes:
a first receiving unit 2301 configured to receive third downlink control information for scheduling uplink data within a first application time, in which at least part of the uplink data is within a second application time, and
a first transmitting unit 2302 configured to determine to perform an uplink data transmission based on a single transmission and reception point (sTRP) or perform an uplink data transmission based on multiple transmission and reception points (mTRP) for the uplink data within the second application time, according to one or more parameters indicated by the third downlink control information and/or at least one uplink transmission configuration indication state (UL TCI state) corresponding to the second application time.

In some embodiments, the uplink data includes at least one of uplink data types:
an uplink repetition (PUSCH repetition) type A;
an uplink repetition (PUSCH repetition) type B; or
a PUSCH transmitted by a plurality of panels simultaneously.

In some embodiments, the first receiving unit receives first downlink control information corresponding to the first application time; and receives second downlink control information corresponding to the second application time within the first application time.

In some embodiments, the parameter indicated by the third downlink control information includes at least one of an SRS resource set, an SRS resource, or an uplink transmit precoding matrix indicator (TPMI).

In some embodiments, this parameter is indicated by an SRS resource set indicator field in the third downlink control information.

In some embodiments, the second downlink control information indicates at least one uplink transmission configuration indication state (UL TCI state) corresponding to the second application time.

In some embodiments, the uplink data within the second application time is transmitted using part or all of the at least one uplink transmission configuration indication state (UL TCI state) corresponding to the second application time or corresponding to the first application time.

In some embodiments, in a case where the parameter indicated by the third downlink control information includes one SRS resource set, the uplink data transmission based on the single transmission and reception point (sTRP) is performed for the uplink data within the second application time. In a case where the parameter includes more than one SRS resource set, the uplink data transmission based on the multiple transmission and reception points (mTRP) is performed for the uplink data within the second application time.

In some embodiments, in a case where the uplink data transmission based on the multiple transmission and reception points (mTRP) is performed for the uplink data within the second application time, and the uplink transmission configuration indication state corresponding to the second application time includes one uplink transmission configuration indication state (UL TCI state), the one uplink transmission configuration indication state (UL TCI state) is associated with more than one SRS resource set.

In some embodiments, the uplink data within the second application time is transmitted using an uplink transmission configuration indication state (UL TCI state) associated with the parameter in at least one uplink transmission configuration indication state (UL TCI state) corresponding to the second application time or corresponding to the first application time, or using a predefined uplink transmission configuration indication state (UL TCI state) in at least one uplink transmission configuration indication state (UL TCI state) corresponding to the second application time.

In some embodiments, the predefined uplink transmission configuration indication state (UL TCI state) is one uplink transmission configuration indication in a specific position in at least one uplink transmission configuration indication state (UL TCI state) corresponding to the second application time.

In some embodiments, at least one of information in the parameters: the SRS resource set, the SRS resource, or the uplink transmit precoding matrix indicator (TPMI) is used to transmit the uplink data within the second application time.

In some embodiments, in a case where the uplink transmission configuration indication state (UL TCI state) corresponding to the second application time includes one uplink transmission configuration indication state (UL TCI state), the uplink data transmission based on the single transmission and reception point (sTRP) is performed for the uplink data within the second application time. In a case where the uplink transmission configuration indication state corresponding to the second application time includes more than one uplink transmission configuration indication state (UL TCI state), the uplink data transmission based on the multiple transmission and reception points (mTRP) is performed within the second application time.

In some embodiments, at least one uplink transmission configuration indication state (UL TCI state) corresponding to the second application time is used to transmit the uplink data within the second application time.

In some embodiments, at least one of information included in the parameters and/or predefined: the SRS resource set, the SRS resource, or the uplink transmit precoding matrix indicator (TPMI) is used to transmit the uplink data within the second application time.

In some embodiments, at least one of the predefined information: the SRS resource set, the SRS resource, or the TPMI is determined according to one of:
two configured SRS resource sets;
one SRS resource set in a specific position in the two configured SRS resource sets;
one SRS resource in a specific position in at least one SRS resource in one SRS resource set;
a first SRS resource with a smallest number of SRS ports in at least one SRS resource in one SRS resource set; or
one TPMI in a specific position in at least one TPMI available for one SRS resource.

In some embodiments, at least one of information associated with the one uplink transmission configuration indication state (UL TCI state) or the more than one uplink transmission configuration indication state (UL TCI state): the SRS resource set, the SRS resource, or the TPMI is used to transmit the uplink data within the second application time.

In some embodiments, for at least one uplink repetition (PUSCH repetition) spanning the first application time and the second application time, the uplink data within the second application time starts from the first uplink repetition (PUSCH repetition) after a moment in which the second application time starts.

In some embodiments, starting from the first uplink repetition (PUSCH repetition) after the moment in which the second application time starts, at least one uplink transmission configuration indication state (UL TCI state) and/or SRS resource set for the uplink data transmission is associated or mapped to K uplink repetitions (PUSCH repetitions), in which a moment in which the K uplink repetitions (PUSCH repetitions) start is within the second application time.

In some embodiments, in a case where two uplink transmission configuration indication states (UL TCI states) and/or SRS resource sets are used for the uplink data transmission, the at least two uplink transmission configuration indication states (UL TCI states) and/or SRS resource sets are mapped to the K uplink repetitions (PUSCH repetitions) in a predefined order.

In some embodiments, the predefined order is:
the first uplink transmission configuration indication state (UL TCI state) and/or SRS resource set, followed by the second uplink transmission configuration indication state (UL TCI state) and/or SRS resource set; or,
the second uplink transmission configuration indication state (UL TCI state) and/or SRS resource set, followed by the first uplink transmission configuration indication state (UL TCI state) and/or SRS resource set.

In some embodiments, in a case where one uplink transmission configuration indication state (UL TCI state) and/or SRS resource set is used for the uplink data transmission, the one uplink transmission configuration indication state (UL TCI state) and/or SRS resource set is mapped to the K uplink repetitions (PUSCH repetitions).

In some embodiments, the K uplink repetitions (PUSCH repetitions) adopt the mapping method between the SRS resource set and the uplink repetitions (PUSCH repetitions) determined according to the third downlink control information.

In some embodiments, the uplink repetitions (PUSCH repetitions) include at least one of a nominal repetition, an actual repetition, a symbol, or a slot.

The above implementations only illustrate the embodiments of this disclosure. However, this disclosure is not limited thereto, and appropriate variants may be made on the basis of these implementations. For example, the above implementations may be executed separately, or one or more of them may be combined together.

It is worth noting that the components or modules related to this disclosure are only described above. However, this disclosure is not limited thereto. The uplink data transmitting device 2300 may also comprise other components or modules. Refer to the related arts for the specific content of these components or modules.

In addition, for the sake of simplicity, FIG. 23 only illustrates a connection relationship or a signaling direction between components or modules, however, those skilled in the art should appreciate that related arts such as bus connections can be adopted. The components or modules can be implemented by hardware facilities, such as a processor, a memory, a transmitter, a receiver, which is not limited in this disclosure.

As can be seen from the embodiments, the terminal equipment determines relevant parameters for the uplink data transmission within the second application time based on the parameters indicated by the third downlink control information and/or at least one uplink transmission configuration indication state (UL TCI state) corresponding to the second application time. Therefore, ambiguity can be avoided in the use of relevant parameters for uplink data transmission, so as to avoid a resulting failure in uplink data transmission.

### Embodiments of an Eighth Aspect

The embodiments of this disclosure provide an uplink data transmitting device. The device may be, for example, a terminal equipment, or may be a or some part(s) or component(s) configured in the terminal equipment. The terminal equipment is configured with two SRS resource sets. In addition, a same content as the embodiments of the second aspect will not be described again.

FIG. 24 is another schematic diagram illustrating the uplink data transmitting device according to an embodiment of this disclosure. As illustrated in FIG. 24, an uplink data transmitting device 2400 includes:
a second receiving unit 2401 configured to receive third downlink control information for scheduling uplink data within a first application time, the uplink data is to be transmitted by the terminal equipment within the first application time; and
a second transmitting unit 2402 configured to determine to perform an uplink data transmission based on a single transmission and reception point (sTRP) or perform an uplink data transmission based on multiple transmission and reception points (mTRP) for the uplink data based on at least one of an SRS resource set, an SRS resource, or a TPMI indicated by the third downlink control information.

Therefore, the terminal equipment transmits the uplink data only within the first application time, and can determine relevant parameters associated with the uplink data, such as at least one of the SRS resource set, the SRS resource, or the TPMI. Therefore, ambiguity can be avoided in the use of relevant parameters for uplink data transmission, so as to avoid a resulting failure in uplink data transmission.

The above implementations only illustrate the embodiments of this disclosure. However, this disclosure is not limited thereto, and appropriate variants may be made on the basis of these implementations. For example, the above implementations may be executed separately, or one or more of them may be combined together.

It is worth noting that the components or modules related to this disclosure are only described above. However, this disclosure is not limited thereto. The uplink data transmitting device 2400 may also include other components or modules. Refer to the related arts for the specific content of these components or modules.

In addition, for the sake of simplicity, FIG. 24 only illustrates a connection relationship or a signaling direction between components or modules, however, those skilled in the art should appreciate that related arts such as bus connections can be adopted. The components or modules can be implemented by hardware facilities, such as a processor, a memory, a transmitter, a receiver, which is not limited in this disclosure.

As can be seen from the embodiments, the terminal equipment transmits the uplink data only within the first application time and can determine relevant parameters associated with the uplink data, such as at least one of the SRS resource set, the SRS resource, or the TPMI. Therefore, ambiguity can be avoided in the use of relevant parameters for uplink data transmission, so as to avoid a resulting failure in uplink data transmission.

### Embodiment of a Ninth Aspect

The embodiments of this disclosure provide an uplink data transmitting device. The device may be, for example, a terminal equipment, or may be a or some part(s) or component(s) configured in the terminal equipment. The terminal equipment is configured with two SRS resource sets. In addition, a same content as the embodiments of the third aspect will not be described again.

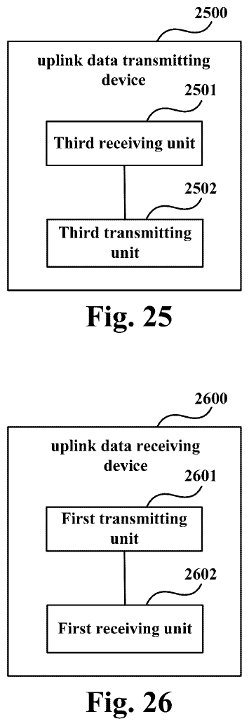

FIG. 25 is another schematic diagram illustrating the uplink data transmitting device according to an embodiment of this disclosure. As illustrated in FIG. 25, an uplink data transmitting device 2500 includes:
a third receiving unit 2501 configured to receive third downlink control information for scheduling uplink data within a first application time, in which at least part of the uplink data is within a second application time; and
a third transmitting unit 2502 configured to transmit no uplink data within the second application time.

Therefore, the terminal equipment transmits the uplink data only within the first application time and does not transmit the uplink data within the second application time. Therefore, relevant parameters associated with the uplink data within the first application time can be determined. Therefore, ambiguity can be avoided in the use of relevant parameters for uplink data transmission, so as to avoid a resulting failure in uplink data transmission.

The above implementations only illustrate the embodiments of this disclosure. However, this disclosure is not limited thereto, and appropriate variants may be made on the basis of these implementations. For example, the above implementations may be executed separately, or one or more of them may be combined together.

It is worth noting that the components or modules related to this disclosure are only described above. However, this disclosure is not limited thereto. The uplink data transmitting device 2500 may also include other components or modules. Refer to the related arts for the specific content of these components or modules.

In addition, for the sake of simplicity, FIG. 25 only illustrates a connection relationship or a signaling direction between components or modules, however, those skilled in the art should appreciate that related arts such as bus connections can be adopted. The components or modules can be implemented by hardware facilities, such as a processor, a memory, a transmitter, a receiver, which is not limited in this disclosure.

As can be seen from the embodiments, the terminal equipment transmits the uplink data only within the first application time and does not transmit the uplink data within the second application time. Therefore, relevant parameters associated with the uplink data within the first application time can be determined. Therefore, ambiguity can be avoided in the use of relevant parameters for uplink data transmission, so as to avoid a resulting failure in uplink data transmission.

### Embodiments of a Tenth Aspect

The embodiments of this disclosure provide an uplink data receiving device. The device may be, for example, a network device, or may be a or some part(s) or component(s) configured in the network device. A same content as the embodiments of the first aspect will not be described again.

FIG. 26 is a schematic diagram illustrating an uplink data receiving device according to an embodiment of this disclosure. As illustrated in FIG. 26, an uplink data receiving device 2600 includes:
a first transmitting unit 2601 configured to transmit third downlink control information for scheduling uplink data to a terminal equipment within a first application time, in which at least part of the uplink data is within a second application time; and in which the terminal equipment is configured with two SRS resource sets; and
a first receiving unit 2602 configured to receive the uplink data within the second application time, in which the terminal equipment determines to perform an uplink data transmission based on a single transmission and reception point (sTRP) or perform an uplink data transmission based on multiple transmission and reception points (mTRP) for the uplink data within the second application time according to one or more parameters indicated by the third downlink control information and/or at least one uplink transmission configuration indication state (UL TCI state) corresponding to the second application time.

The above implementations only illustrate the embodiments of this disclosure. However, this disclosure is not limited thereto, and appropriate variants may be made on the basis of these implementations. For example, the above implementations may be executed separately, or one or more of them can be combined together.

It is worth noting that the components or modules related to this disclosure are only described above. However, this disclosure is not limited thereto. The uplink data receiving device 2600 may also include other components or modules. Refer to the related arts for the specific content of these components or modules.

In addition, for the sake of simplicity, FIG. 26 only illustrates a connection relationship or a signaling direction between components or modules, however, those skilled in the art should appreciate that related arts such as bus connections can be adopted. The components or modules can be implemented by hardware facilities, such as a processor, a memory, a transmitter, a receiver, which is not limited in this disclosure.

As can be seen from the embodiments, the terminal equipment determines relevant parameters for uplink data transmission within the second application time based on the parameters indicated by the third downlink control information and/or at least one uplink transmission configuration indication state (UL TCI state) corresponding to the second application time. Therefore, ambiguity can be avoided in the use of relevant parameters for uplink data transmission, so as to avoid a resulting failure in uplink data transmission.

### Embodiment of an Eleventh Aspect

The embodiments of this disclosure provide an uplink data receiving device. The device may be, for example, a network device, or may be a or some part(s) or component(s) configured in the network device. A same content as the embodiments of the second aspect will not be described again.

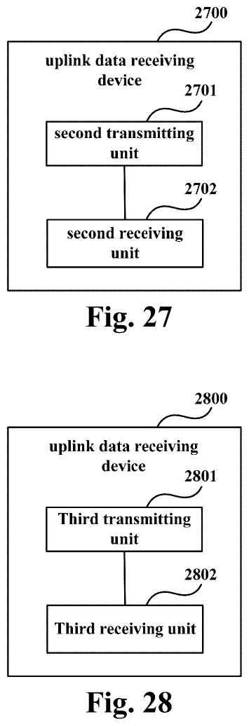

FIG. 27 is another schematic diagram illustrating an uplink data receiving device according to an embodiment of this disclosure. As illustrated in FIG. 27, an uplink data receiving device 2700 includes:
a second transmitting unit 2701 configured to transmit third downlink control information for scheduling uplink data to a terminal equipment within a first application time, in which the terminal equipment is configured with two SRS resource sets; and
a second receiving unit 2702 configured to receive the uplink data within the first application time, in which the terminal equipment determines to perform an uplink data transmission based on a single transmission and reception point (sTRP) or perform an uplink data transmission based on multiple transmission and reception points (mTRP) for the uplink data, based on at least one of an SRS resource set, an SRS resource, or a TPMI indicated by the third downlink control information.

The above implementations only illustrate the embodiments of this disclosure. However, this disclosure is not limited thereto, and appropriate variants may be made on the basis of these implementations. For example, the above implementations may be executed separately, or one or more of them may be combined together.

It is worth noting that the components or modules related to this disclosure are only described above. However, this disclosure is not limited thereto. The uplink data receiving device 2700 may also include other components or modules. Refer to the related arts for the specific content of these components or modules.

In addition, for the sake of simplicity, FIG. 27 only illustrates a connection relationship or a signaling direction between components or modules, however, those skilled in the art should appreciate that related arts such as bus connections can be adopted. The components or modules can be implemented by hardware facilities, such as a processor, a memory, a transmitter, a receiver, which is not limited in this disclosure.

As can be seen from the embodiments, the terminal equipment transmits the uplink data only within the first application time, and can determine relevant parameters associated with the uplink data, such as at least one of the SRS resource set, the SRS resource, or the TPMI. Therefore, ambiguity can be avoided in the use of relevant parameters for uplink data transmission, so as to avoid a resulting failure in uplink data transmission.

### Embodiment of a Twelfth Aspect

The embodiments of this disclosure provide an uplink data receiving device. The device may be, for example, a network device, or may be a or some part(s) or component(s) configured in the network device. A same content as the embodiments of the third aspect will not be described again.

FIG. 28 is another schematic diagram illustrating the uplink data receiving device according to an embodiment of this disclosure. As illustrated in FIG. 28, an uplink data receiving device 2800 includes:
a third receiving unit 2801 configured to transmit third downlink control information for scheduling uplink data to a terminal equipment within a first application time, in which at least part of the uplink data is within a second application time; and in which the terminal equipment is configured with two SRS resource sets; and
a third transmitting unit 2802 configured to, in the second application time, receive no uplink data within the second application time, in which the terminal equipment does not transmit the uplink data within the second application time.

The above implementations only illustrate the embodiments of this disclosure. However, this disclosure is not limited thereto, and appropriate variants may be made on the basis of these implementations. For example, the above implementations may be executed separately, or one or more of them can be combined together.

It is worth noting that the components or modules related to this disclosure are only described above. However, this disclosure is not limited thereto. The uplink data receiving device 2800 may also include other components or modules. Refer to the related arts for the specific content of these components or modules.

In addition, for the sake of simplicity, FIG. 28 only illustrates a connection relationship or a signaling direction between components or modules, however, those skilled in the art should appreciate that related arts such as bus connections can be adopted. The components or modules can be implemented by hardware facilities, such as a processor, a memory, a transmitter, a receiver, which is not limited in this disclosure.

As can be seen from the embodiments, the terminal equipment transmits the uplink data only within the first application time and does not transmit the uplink data within the second application time. Thus, relevant parameters associated with the uplink data within the first application time can be determined. Therefore, ambiguity can be avoided in the use of relevant parameters for uplink data transmission, so as to avoid a resulting failure in uplink data transmission.

### Embodiments of a Thirteenth Aspect

The embodiments of this disclosure also provide a communication system. Refer to FIG. 1. A same content as the embodiments of the first to twelfth aspects will not be described again.

In some embodiments, a communication system 100 may at least include:
a network device configured to transmit third downlink control information for scheduling uplink data to a terminal equipment within a first application time, in which at least part of the uplink data is within a second application time; and
the terminal equipment configured with two SRS resource sets, and configured to determine to perform an uplink data transmission based on a single transmission and reception point (sTRP) or perform an uplink data transmission based on multiple transmission and reception points (mTRP) for the uplink data within the second application time, according to the parameters indicated by the third downlink control information and/or at least one uplink transmission configuration state (UL TCI state) corresponding to the second application time.

The network device receives the uplink data within the second application time.

In some embodiments, the communication system 100 may also at least include:
a network device configured to transmit third downlink control information for scheduling uplink data to a terminal equipment within a first application time; and
the terminal equipment configured with two SRS resource sets, and configured to determine to perform an uplink data transmission based on a single transmission and reception point (sTRP) or perform an uplink data transmission based on multiple transmission and reception points (mTRP) for the uplink data, based on at least one of an SRS resource set, an SRS resource, or a TPMI indicated by the third downlink control information.

The network device receives the uplink data within the first application time.

In some embodiments, the communication system 100 may also at least include:
a network device configured to transmit third downlink control information for scheduling uplink data to a terminal equipment within a first application time, in which at least part of the uplink data is within a second application time; and
the terminal equipment configured with two SRS resource sets; and configured to transmit no uplink data within the second application time.

The network device, in the second application time, does not receive the uplink data within the second application time.

The embodiments of this disclosure also provide a network device, which may be, for example, a base station, which is not limited in this disclosure, and may also be other network device.

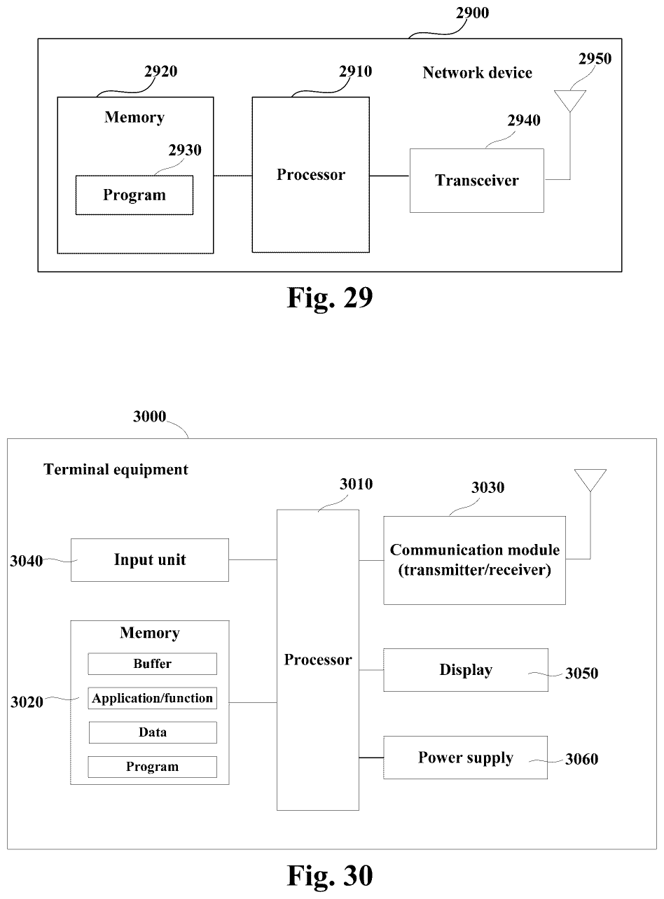

FIG. 29 is a schematic diagram illustrating a composition of a network device according to an embodiment of this disclosure. As illustrated in FIG. 29, a network device 2900 may include: a processor 2910 (e.g., a central processing unit CPU) and a memory 2920 coupled to the processor 2910. The memory 2920 may store various data, and also store an information processing program 2930 that is executed under the control of the processor 2910.

In addition, as illustrated in FIG. 29, the network device 2900 may also include: a transceiver 2940 and an antenna 2950. The functions of the components are similar to those of the relevant art and will not be described here again. It is worth noting that the network device 2900 does not necessarily include all the components illustrated in FIG. 29. In addition, the network device 2900 may also include the components not illustrated in FIG. 29. Please refer to the relevant art.

The embodiments of this disclosure also provide a terminal equipment, which is not limited in this disclosure, and may also be other devices.

FIG. 30 is a schematic diagram illustrating a terminal equipment according to an embodiment of this disclosure. As illustrated in FIG. 30, a terminal equipment 3000 may include a processor 3010 and a memory 3020. The memory 3020 stores data and a program and is coupled to the processor 3010. It is worth noting that this figure is exemplary; and other types of structures may also be used to supplement or replace this structure in order to implement telecommunications functions or other functions.

For example, the processor 3010 may be configured to execute a program to implement the uplink data transmitting method in the embodiments of the first aspect. For example, the processor 3010 may be configured with two SRS resource sets; configured to receive third downlink control information for scheduling uplink data within a first application time, in which at least part of the uplink data is within a second application time; and perform an uplink data transmission based on a single transmission and reception point (sTRP) or perform an uplink data transmission based on multiple transmission and reception points (mTRP), according to one or more parameters indicated by the third downlink control information and/or at least one uplink transmission configuration indication state (UL TCI state) corresponding to the second application time.

As illustrated in FIG. 30, the terminal equipment 3000 may also include: a communication module 3030, an input unit 3040, a display 3050, and a power supply 3060. The functions of the components are similar to those in the related art and will not be described here again. It is worth noting that the terminal equipment 3000 does not necessarily include all the components illustrated in FIG. 30, and the above components are not necessarily required. In addition, the terminal equipment 3000 may also include the components not illustrated in FIG. 30. Please refer to the relevant art.

The embodiments of this disclosure also provide a computer program, wherein when a program is executed in a terminal equipment, the terminal equipment implements the uplink data transmitting method in the embodiments of the first to third aspects due to the program.

The embodiments of this disclosure also provide a storage medium storing a computer program, wherein the terminal equipment implements the uplink data transmitting method in the embodiments of the first to third aspects due to the computer program.

The embodiments of this disclosure also provide a computer program, wherein when a program is executed in a terminal equipment, the terminal equipment implements the uplink data receiving method in the embodiments of the fourth to sixth aspects due to the program.

The embodiments of this disclosure also provide a storage medium storing a computer program, wherein the terminal equipment implements the uplink data receiving method in the embodiments of the fourth to sixth aspects due to the computer program.

The above devices and methods of this disclosure may be implemented by hardware, or by hardware in combination with software. This disclosure relates to such a computer-readable program that when the program is executed by a logic device, the logic device is enabled to carry out the device or components as described above, or to carry out the methods or steps as described above. This disclosure also relates to a storage medium for storing the above program, such as a hard disk, a floppy disk, a CD, a DVD, and a flash memory, etc.

The methods/devices described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And these hardware modules, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.

As to implementations containing the above embodiments, supplements are further disclosed below.

1. A method of transmitting uplink data applied to a terminal equipment configured with two SRS resource sets, including:
receiving, by the terminal equipment, third downlink control information for scheduling uplink data within a first application time, in which at least part of the uplink data is within a second application time; and
determining, by the terminal equipment, to perform an uplink data transmission based on a single transmission and reception point (sTRP), or perform an uplink data transmission based on multiple transmission and reception points (mTRP) for the uplink data within the second application time, according to one or more parameters indicated by the third downlink control information and/or at least one uplink transmission configuration indication state (UL TCI state) corresponding to the second application time.

2. The method according to supplement 1, wherein the uplink data includes at least one of uplink data types:
an uplink repetition (PUSCH repetition) type A;
an uplink repetition (PUSCH repetition) type B; or
a PUSCH transmitted by a plurality of panels simultaneously.

3. The method according to supplement 1, wherein the terminal equipment receives first downlink control information corresponding to the first application time; and receives second downlink control information corresponding to the second application time within the first application time.

4. The method according to supplement 1, wherein the parameters include at least one of an SRS resource set, an SRS resource, or a TPMI.

5. The method according to supplement 4, wherein the parameters are indicated by an SRS resource set indicator field in the third downlink control information.

6. The method according to supplement 3, wherein the second downlink control information indicates the at least one uplink transmission configuration indication state (UL TCI state) corresponding to the second application time.

7. The method according to supplement 1, wherein part or all of at least one uplink transmission configuration indication states (UL TCI state) corresponding to the second application time or corresponding to the first application time are used to transmit the uplink data within the second application time.

8. The method according to supplement 7, wherein in a case where the parameters include one SRS resource set, an uplink data transmission based on a single transmission and reception point (sTRP) is performed for the uplink data within the second application time; and in a case where the parameters include more than one SRS resource set, an uplink data transmission based on multiple transmission and reception points (mTRP) is performed for the uplink data within the second application time.

9. The method according to supplement 8, wherein in a case where the uplink data transmission based on the multiple transmission and reception points (mTRP) is performed for the uplink data within the second application time, and the uplink transmission configuration indication state (UL TCI) corresponding to the second application time includes one uplink transmission configuration indication state (UL TCI state), the one uplink transmission configuration indication state (UL TCI state) is associated with the more than one SRS resource set.

10. The method according to supplement 8, wherein an uplink transmission configuration indication state (UL TCI state) associated with the parameters in at least one uplink transmission configuration indication state (UL TCI state) corresponding to the second application time or corresponding to the first application time, or a predefined uplink transmission configuration indication state (UL TCI state) in at least one uplink transmission configuration indication state (UL TCI state) corresponding to the second application time is used to transmit the uplink data within the second application time.

11. The method according to supplement 10, wherein the predefined uplink transmission configuration indication state (UL TCI state) is one uplink transmission configuration indication state (UL TCI state) in a specific position in at least one uplink transmission configuration indication state (UL TCI state) corresponding to the second application time.

12. The method according to supplement 8, wherein at least one of information in the parameters: an SRS resource set, an SRS resource, or a TPMI is used to transmit the uplink data within the second application time.

13. The method according to supplement 7, wherein in a case where the uplink transmission configuration indication state (UL TCI state) corresponding to the second application time includes one uplink transmission configuration indication state (UL TCI state), the uplink data transmission based on the single transmission and reception point (sTRP) is performed for the uplink data within the second application time; and in a case where the uplink transmission configuration indication state corresponding to the second application time includes more than one uplink transmission configuration indication state (UL TCI state), the uplink data transmission based on the multiple transmission and reception points (mTRP) is performed for the uplink data within the second application time.

14. The method according to supplement 13, wherein the uplink data within the second application time is transmitted using at least one uplink transmission configuration indication state (UL TCI state) corresponding to the second application time.

15. The method according to supplement 13, wherein at least one of information included in the parameters and/or predefined: an SRS resource set, an SRS resource, or a TPMI is used to transmit the uplink data within the second application time.

16. The method according to supplement 15, wherein at least one of the predefined information: the SRS resource set, the SRS resource, or the TPMI is determined according to one of:
two configured SRS resource sets;
one SRS resource set in a specific position in the two configured SRS resource sets;
one SRS resource in a specific position in at least one SRS resource in one SRS resource set;
a first SRS resource with a smallest number of SRS ports in at least one SRS resource in one SRS resource set; and
one TPMI in a specific position in at least one TPMI available for one SRS resource.

17. The method according to supplement 13, wherein at least one of information associated with the one uplink transmission configuration indication state (UL TCI state) or the more than one uplink transmission configuration indication state (UL TCI state): the SRS resource set, the SRS resource, or the TPMI is used to transmit the uplink data within the second application time.

18. The method according to any one of supplements 1-17, wherein for at least one uplink repetition (PUSCH repetition) spanning the first application time and the second application time, the uplink data within the second application time starts from a first uplink repetition (PUSCH repetition) after a moment in which the second application time starts.

19. The method according to supplement 18, wherein starting from the first uplink repetition (PUSCH repetition) after the moment in which the second application time starts, at least one uplink transmission configuration indication state (UL TCI state) and/or SRS resource set for the uplink data transmission is associated or mapped to K uplink repetitions (PUSCH repetitions), in which a moment in which the K uplink repetitions (PUSCH repetitions) start is within the second application time.

20. The method according to supplement 19, wherein in a case where two uplink transmission configuration indication states (UL TCI state) and/or SRS resource sets are used for the uplink data transmission, the at least two uplink transmission configuration indication states (UL TCI state) and/or SRS resource sets are mapped to the K uplink repetitions (PUSCH repetitions) in a predefined order.

21. The method according to supplement 20, wherein the predefined order is: a first uplink transmission configuration indication state (UL TCI state) and/or SRS resource set, followed by a second uplink transmission configuration indication state (UL TCI state) and/or SRS resource set; or, a second uplink transmission configuration indication state (UL TCI state) and/or SRS resource set, followed by a first uplink transmission configuration indication state (UL TCI state) and/or SRS resource set.

22. The method according to supplement 19, wherein in a case where one uplink transmission configuration indication state (UL TCI state) and/or SRS resource set is used for the uplink data transmission, the one uplink transmission configuration indication state (UL TCI state) and/or SRS resource set is mapped to the K uplink repetitions (PUSCH repetitions).

23. The method according to supplement 19, wherein the K uplink repetitions (PUSCH repetitions) use a mapping method between the SRS resource set and the uplink repetitions (PUSCH repetitions) determined according to the third downlink control information.

24. The method according to any one of supplements 18-23, wherein the uplink repetitions (PUSCH repetitions) include at least one of a nominal repetition, an actual repetition, a symbol, and a time slot.

25. A method of transmitting uplink data applied to a terminal equipment, including:
receiving, by the terminal equipment, third downlink control information for scheduling uplink data within a first application time, transmitting, by the terminal equipment, the uplink data within the first application time; and
determining, by the terminal equipment, based on at least one of an SRS resource set, an SRS resource, or a TPMI indicated by the third downlink control information, to perform an uplink data transmission based on a single transmission and reception point (sTRP), or perform an uplink data transmission based on multiple transmission and reception points (mTRP) for the uplink data, wherein the terminal equipment is configured with two SRS resource sets.

26. A method of transmitting uplink data applied to a terminal equipment, including:
receiving, by the terminal equipment, third downlink control information for scheduling uplink data within a first application time, in which at least part of the uplink data is within a second application time; and
transmitting, by the terminal equipment, no uplink data within the second application time, wherein the terminal equipment is configured with two SRS resource sets.

27. A method of receiving uplink data applied to a network device, including:
transmitting, by the network device, third downlink control information for scheduling uplink data to a terminal equipment within a first application time, in which at least part of the uplink data is within a second application time; and
receiving, by the network device, the uplink data within the second application time, in which the terminal equipment determines to perform an uplink data transmission based on a single transmission and reception point (sTRP), or perform an uplink data transmission based on multiple transmission and reception points (mTRP) for the uplink data within the second application time according to one or more parameters indicated by the third downlink control information and/or at least one uplink transmission configuration indication state (UL TCI state) corresponding to the second application time, wherein the terminal equipment is configured with two SRS resource sets.

28. A method of receiving uplink data applied to a network device, including:
transmitting, by the network device, third downlink control information for scheduling uplink data to a terminal equipment within a first application time;
receiving, by the network device, the uplink data within the first application time, wherein the terminal equipment determines to perform an uplink data transmission based on a single transmission and reception point (sTRP), or perform an uplink data transmission based on multiple transmission and reception points (mTRP) for the uplink data based on at least one of an SRS resource set, an SRS resource, or a TPMI indicated by the third downlink control information, wherein the terminal equipment is configured with two SRS resource sets.

29. A method of receiving uplink data applied to a network device, including:
transmitting, by the network device, third downlink control information for scheduling uplink data to a terminal equipment within a first application time, in which at least part of the uplink data is within a second application time; and
receiving, by the network device, no uplink data within the second application time within the second application time, in which the terminal equipment does not transmit the uplink data within the second application time, wherein the terminal equipment is configured with two SRS resource sets.

30. A terminal equipment, including a memory storing a computer program, and a processor configured to execute the computer program to implement the method of transmitting uplink data according to any one of supplements 1 to 26.

31. A network device, including a memory storing a computer program, and a processor configured to execute the computer program to implement the method of receiving uplink data according to any one of supplements 27 to 29.

32. A communication system, including:
a network device configured to transmit third downlink control information for scheduling uplink data to a terminal equipment within a first application time, in which at least part of the uplink data is within a second application time; and
the terminal equipment configured with two SRS resource sets; and configured to determine to perform an uplink data transmission based on a single transmission and reception point (sTRP), or perform an uplink data transmission based on multiple transmission and reception points (mTRP) for the uplink data within the second application time according to one or more parameters indicated by the third downlink control information and/or at least one uplink transmission configuration indication state (UL TCI state) corresponding to the second application time, the network device receiving the uplink data within the second application time.

33. A communication system, including:
a network device configured to transmit third downlink control information for scheduling uplink data to a terminal equipment within a first application time; and
the terminal equipment configured with two SRS resource sets, and configured to determine to perform an uplink data transmission based on a single transmission and reception point (sTRP), or perform an uplink data transmission based on multiple transmission and reception points (mTRP) for the uplink data based on at least one of an SRS resource set, an SRS resource, and a TPMI indicated by the third downlink control information, and the network device receiving the uplink data within the first application time.

34. A communication system, including:
a network device configured to transmit third downlink control information for scheduling uplink data to a terminal equipment within a first application time, wherein at least part of the uplink data is within a second application time; and
the terminal equipment configured with two SRS resource sets; and configured to transmit no uplink data within the second application time; and the network device receiving no uplink data within the second application time within the second application time.

What is claimed is:

1. An uplink data transmitting device configured in a terminal equipment, wherein the terminal equipment is configured with two SRS resource sets, the device comprising:
a first receiver configured to receive third downlink control information for scheduling uplink data within a first application time, wherein at least part of the uplink data is within a second application time; and
a first transmitter configured to determine to perform a first uplink data transmission based on a single transmission and reception point (sTRP) or perform a second uplink data transmission based on multiple transmission and reception points (mTRP) for the uplink data within the second application time, according to one or more parameters indicated by the third downlink control information;
wherein the uplink data comprises at least one of uplink data types:
an uplink repetition (PUSCH repetition) type A;
an uplink repetition (PUSCH repetition) type B; or
PUSCHs simultaneously transmitted with a multi-panel transmission scheme;
wherein the first receiver receives first downlink control information corresponding to the first application time; and receives second downlink control information corresponding to the second application time within the first application time;
wherein the first downlink control information indicates two uplink transmission configuration indication (UL TCI) states corresponding to the first application time, and the second downlink control information indicates one uplink transmission configuration indication (UL TCI) state corresponding to the second application time.

2. The device according to claim 1, wherein the parameters comprise at least one of an SRS resource set, an SRS resource, or an uplink transmit precoding matrix indicator (TPMI).

3. The device according to claim 2, wherein the parameters are indicated by an SRS resource set indicator field in the third downlink control information.

4. The device according to claim 1, wherein the one uplink transmission configuration indication state (UL TCI state) corresponding to the second application time is used to transmit the uplink data within the second application time.

5. The apparatus according to claim 1, wherein,
a part of uplink transmission configuration indication states (UL TCI states) in the two uplink transmission configuration indication (UL TCI) states corresponding to the first application time is used to transmit the uplink data within the second application time.

6. The device according to claim 1, wherein
in a case where the parameters comprise one SRS resource set, the first uplink data transmission based on a single transmission and reception point (sTRP) is performed for the uplink data within the second application time; and
in a case where the parameters comprise more than one SRS resource set, the second uplink data transmission based on multiple transmission and reception points (mTRP) is performed for the uplink data within the second application time.

7. The device according to claim 6, wherein an uplink transmission configuration indication state (UL TCI state) associated with the parameter in at least one uplink transmission configuration indication state (UL TCI state) corresponding to the second application time or corresponding to the first application time is used to transmit the uplink data within the second application time.

8. The device according to claim 6, wherein at least one of information in the parameters: an SRS resource set, an SRS resource, or an uplink transmit precoding matrix indicator (TPMI) is used to transmit the uplink data within the second application time.

9. An apparatus for receiving uplink data from a terminal equipment, configured in a network device, wherein the terminal equipment is configured with two SRS resource sets, the apparatus comprising:
a first transmitter configured to transmit third downlink control information for scheduling uplink data during a first application time, wherein the uplink data is at least partially within a second application time; and
a first receiver configured to receive the uplink data transmitted by the terminal equipment using an uplink data transmission which is determined, according to one or more parameters indicated by the third downlink control information, from among a first uplink data transmission based on a single transmission and reception point (sTRP) or a second uplink data transmission based on multiple transmission and reception points (mTRPs) for the uplink data within the second application time;
wherein the uplink data comprise at least one of the following uplink data types:
an PUSCH repetition Type A;
an PUSCH repetition Type B; or
PUSCHs simultaneously transmitted with a multi-panel transmission scheme;
wherein first transmitter transmits first downlink control information corresponding to the first application time, and transmits second downlink control information corresponding to the second application time within the first application time;
wherein the first downlink control information indicates two uplink transmission configuration indication (UL TCI) states corresponding to the first application time, and the second downlink control information indicates one uplink transmission configuration indication (UL TCI) state corresponding to the second application time.

10. The apparatus according to claim 9, wherein,
the parameters comprise at least one of an SRS resource set, an SRS resource, or an uplink precoding index (transmit precoding matrix indicator, TPMI).

11. The apparatus according to claim 9, wherein,
the parameters are indicated by an SRS resource set indicator field in the third downlink control information.

12. The apparatus according to claim 9, wherein,
the uplink data within the second application time is transmitted by using the one uplink transmission configuration indication (UL TCI) state corresponding to the second application time.

13. The apparatus according to claim 9, wherein,
the uplink data within the second application time is transmitted by using a part of uplink transmission configuration indication states (UL TCI states) in the two uplink transmission configuration indication (UL TCI) states corresponding to the first application time.

14. The apparatus according to claim 9, wherein,
in a case where the parameters comprise one SRS resource set, the first uplink data transmission based on a single transmission and reception point (sTRP) is performed for the uplink data within the second application time;
and in a case where the parameters comprise more than one SRS resource sets, the second uplink data transmission based on multiple transmission and reception points (mTRPs) is performed for the uplink data within the second application time.

15. The apparatus according to claim 14, wherein,
the uplink data within the second application time is transmitted by using an uplink transmission configuration indication (UL TCI) state associated with the parameter in at least one uplink transmission configuration indication (UL TCI) state corresponding to the second application time or corresponding to the first application time.

16. The apparatus according to claim 14, wherein,
the uplink data within the second application time is transmitted by using at least one of the following information in the parameters: an SRS resource set, an SRS resource, or an uplink precoding index (transmit precoding matrix indicator, TPMI).
